(19) United States
(12) Patent Application Publication
(10) Pub. No.: US 2021/0107824 A1
(43) Pub. Date: Apr. 15, 2021

(54) SYSTEM AND METHOD FOR RECLAMATION OF LEADED GLASS

(71) Applicant: GKAT RECLAMATION, LLC, Des Moines, IA (US)

(72) Inventor: Michael Seiler, Des Moines, IA (US)

(21) Appl. No.: 17/066,142

(22) Filed: Oct. 8, 2020

Related U.S. Application Data
(60) Provisional application No. 62/913,293, filed on Oct. 10, 2019.

(51) Int. Cl. C03C 3/07; C22B 3/00; C03C 19/00; C22B 13/06; C22B 3/04

(52) U.S. Cl. CPC C03C 3/07; C22B 13/045; C22B 3/045; C22B 13/06; C03C 19/00

(57) ABSTRACT

A system and method for processing leaded glass are presented, in which glass input is tumbled within the cylinder of a ball mill while it is being exposed to an electrolytic fluid. As the glass input is tumbled, balls within the ball mill pulverize the glass input into pulverized glass input particulate matter thereby exposing lead or other heavy metals contained within the glass input to a surface of the pulverized glass input particulate matter. The exposed lead or other heavy metals are largely dissolved by the electrolytic fluid leaving a mostly lead or heavy metal free pulverized glass input particulate matter. A reagent is applied to the pulverized glass input particulate matter to neutralize any residual lead or heavy metal within the pulverized glass input particulate matter thereby allowing the processed pulverized glass input particulate matter to pass a Toxicity Characteristic Leaching Procedure (TCLP) environmental test.

### CROSS-REFERENCE TO RELATED APPLICATIONS

The present application claims priority to U.S. Provisional Application No. 62/913,293, titled SYSTEM AND METHOD FOR RECLAMATION OF LEADED GLASS, and filed on Oct. 10, 2019, the entirety of which is hereby incorporated by reference herein in its entirety, including any figures, tables, or drawings or other information.

### FIELD OF THE DISCLOSURE

This disclosure generally relates to recycling. More specifically and without limitation, this disclosure relates to systems and methods of recycling leaded glass as well as other materials.

### OVERVIEW OF THE DISCLOSURE

Glass is a ceramic material that has been used for centuries for countless purposes such as for windows, containers, dinnerware, lenses, medical equipment, industrial equipment, and electronic equipment, among countless other applications. There are countless chemical compositions of glass. As the chemical composition of glass is modified, the properties of the glass are modified such as the color, weight, strength, opacity, among other properties. The foundational chemical composition of glass is silica, also known as SiO₂, also known as silicon dioxide.

Of particular importance to this disclosure is what is known as leaded glass. Leaded glass is a type of glass, or a chemical composition of glass, that includes lead (Pb), as a constituent part of the glass. This lead often takes the form of lead oxide, also known as PbO which is suspended in a glass matrix and is stable and immobile.

Of particular importance to this disclosure, leaded glass is often used in cathode ray tubes (CRTs) used in televisions and computer monitors. Lead is used in CRTs to protect users from potentially harmful exposure to radiation generated during use of the CRT. As an example, the typical 27′ CRT includes in the range of five to seven pounds of lead in it.

Televisions and computer monitors having CRTs have been manufactured in massive quantities over the last ˜60 years. However, due to the development of new and better technologies, these CRT televisions and monitors have been discarded in large-scale over the recent years.

Due to the lead content of these CRTs, these televisions and monitors can be considered hazardous waste. If these CRTs are disposed of improperly, they can have damaging effects on the environment. However, handling discarded CRTs is inherently difficult.

One existing process for handling discarded CRTs is to melt them down, also known as smelting. This smelting process may be used to separate the lead from the glass. However, this smelting process has many drawbacks. Namely, this smelting process is highly energy intensive, it requires highly specialized equipment and processes due to the extremely high temperatures used, and it can have negative environmental impacts due to the release of material into the air.

As such, there is a need for an improved system and method for reclamation of leaded glass.

Thus, it is a primary object of the disclosure to provide a system and method for reclamation of leaded glass that improves upon the state of the art.

Another object of the disclosure is to provide a system and method for reclamation of leaded glass that is more environmentally friendly than existing systems and methods.

Yet another object of the disclosure is to provide a system and method for reclamation of leaded glass that is more efficient than existing systems and methods.

Another object of the disclosure is to provide a system and method for reclamation of leaded glass that is safer to use than existing systems and methods.

Yet another object of the disclosure is to provide a system and method for reclamation of leaded glass that does not require melting of the glass to remove lead.

Another object of the disclosure is to provide a system and method for reclamation of leaded glass that does not require high temperatures.

Yet another object of the disclosure is to provide a system and method for reclamation of leaded glass that reduces emissions into the atmosphere as compared to existing systems and methods.

Another object of the disclosure is to provide a system and method for reclamation of leaded glass that is cost effective to use.

Yet another object of the disclosure is to provide a system and method for reclamation of leaded glass that can be used with a variety of input materials.

Another object of the disclosure is to provide a system and method for reclamation of leaded glass that is not limited to use with just television and computer monitor CRTs

Yet another object of the disclosure is to provide a system and method for reclamation of leaded glass that can be used with flat-screen televisions, flat screen computer monitors, lighting products and solar panels.

Another object of the disclosure is to provide a system and method for reclamation of leaded glass that is repeatable.

Yet another object of the disclosure is to provide a system and method for reclamation of leaded glass that is highly efficient.

Another object of the disclosure is to provide a system and method for reclamation of leaded glass that provides high-quality results.

Yet another object of the disclosure is to provide a system and method for reclamation of leaded glass that that removes a high percentage of lead from glass.

Another object of the disclosure is to provide a system and method for reclamation of leaded glass that utilizes a chemical process rather than a smelting process.

Yet another object of the disclosure is to provide a system and method for reclamation of leaded glass that is easy to use.

Another object of the disclosure is to provide a system and method for reclamation of leaded glass that has a relatively simple design.

Yet another object of the disclosure is to provide a system for reclamation of leaded glass that is robust.

Another object of the disclosure is to provide a system for reclamation of leaded glass that has a long useful life.

Yet another object of the disclosure is to provide a system for reclamation of leaded glass that has relatively few components.

Another object of the disclosure is to provide a system and method for reclamation of leaded glass that use a minimum number of parts.

Yet another object of the disclosure is to provide a system for reclamation of leaded glass that is relatively easy to set-up and install.

Another object of the disclosure is to provide a system and method for reclamation of leaded glass that is environmentally friendly.

Yet another object of the disclosure is to provide a system and method for reclamation of leaded glass that will improve recycling rates of leaded glass.

Another object of the disclosure is to provide a system and method for reclamation of leaded glass that will reduce the amount of leaded glass that is improperly disposed of in landfills.

Yet another object of the disclosure is to provide a system and method for reclamation of leaded glass that allows for the non-thermal recovery of lead from glass.

These and other objects, features, or advantages of the present disclosure will become apparent from the specification, claims and drawings.

### SUMMARY OF THE DISCLOSURE

In one or more arrangements, a system and method for processing leaded glass is presented wherein the glass input is tumbled within the cylinder of a ball mill which causes physical interaction, breaking and abrasion of the glass input while it is being exposed to an electrolytic fluid. As the glass input is tumbled, balls within the ball mill pulverize the glass input into pulverized glass input particulate matter thereby exposing lead or other heavy metals contained within the glass input to a surface of the pulverized glass input particulate matter. The exposed lead or other heavy metals are largely dissolved by the electrolytic fluid leaving a mostly lead or heavy metal free pulverized glass input particulate matter. A reagent is applied to the pulverized glass input particulate matter to neutralize any residual lead or heavy metal within the pulverized glass input particulate matter thereby allowing the processed pulverized glass input particulate matter to pass a Toxicity Characteristic Leaching Procedure (TCLP) environmental test. In this way, use of this system and method eliminates the need to smelt glass having a lead or heavy metal content therein to remove the lead or heavy metals from the glass. Note, the output from the system will never be 100% free from lead or heavy metals, and the TCLP test reflects that there is an allowance for a residual amount of lead or heavy metal that may remain, however the majority of the lead or heavy metal is removed and the remaining lead or heavy metal is stabilized and/or is prevented from leaching to acceptable levels.

### BRIEF DESCRIPTION OF THE DRAWINGS

FIG. 1 shows a top floor plan view of a system for reclamation, in accordance with one or more embodiments.

FIG. 2 shows a television, housing and cathode ray tube, in accordance with one or more embodiments.

FIG. 3 shows a diagram of a cathode ray tube, in accordance with one or more embodiments.

FIG. 4 shows a cross sectional view of an example glass input. in accordance with one or more embodiments; the view showing the glass input infused with a lead oxide.

FIG. 5 shows lower side outlet end perspective view of a trommel for use in a reclamation system, in accordance with one or more embodiments.

FIG. 6 shows an upper side outlet end perspective view of a trommel for use in a reclamation system, in accordance with one or more embodiments; the view showing exterior housing of the trommel omitted with perforated material in view.

FIG. 7 shows a side inlet end perspective view of a ball mill for use in a reclamation system, in accordance with one or mor embodiments.

FIG. 8 shows a side cross section view of a ball mill for use in a reclamation system, in accordance with one or mor embodiments.

FIG. 9 shows a top cross section view of a ball mill for use in a reclamation system, in accordance with one or mor embodiments.

FIG. 10 shows an end view of a ball mill for use in a reclamation system, in accordance with one or mor embodiments.

FIG. 11 shows front view of a sump conveyor for use in a reclamation system, in accordance with one or mor embodiments.

FIG. 12 shows side cross section A of the sump conveyor shown in FIG. 11, in accordance with one or mor embodiments.

FIG. 13 shows a front view of a sump conveyor for use in a reclamation system, in accordance with one or mor embodiments.

FIG. 14 shows side cross section B of the sump conveyor shown in FIG. 13, in accordance with one or mor embodiments.

FIG. 15 shows a diagram of a glass weigh conveyor for use in a reclamation system, in accordance with one or mor embodiments.

FIG. 16 shows a side view of a glass treatment feeder for use in a reclamation system, in accordance with one or mor embodiments.

FIG. 17 shows a top view of the glass treatment feeder shown in FIG. 16, in accordance with one or mor embodiments.

FIG. 18 shows a cross section C of the glass treatment feeder shown in FIG. 16, in accordance with one or mor embodiments.

FIG. 19 shows a side view of an electrolysis machine for use in a reclamation system, in accordance with one or more embodiments.

FIG. 20 shows a cross section D of the electrolysis machine shown in FIG. 19, in accordance with one or more embodiments.

FIG. 21 shows an upper front side perspective view of an electrolysis machine for use in a reclamation system, in accordance with one or more embodiments.

FIG. 22 shows a front view of the electrolysis machine shown in FIG. 21, in accordance with one or more embodiments.

FIG. 23 shows a top view of the electrolysis machine shown in FIG. 21, in accordance with one or more embodiments.

FIG. 24 shows a flow diagram of an example process for reclamation of heavy metals from a bulk input material, in accordance with one or more embodiments.

FIG. 25 depicts two example processes for removing lead from an example glass input by an electrolytic fluid.

FIG. 26 shows a top floor plan view of a system for production of smelter flux, in accordance with one or more embodiments.

FIG. 27 shows a flow diagram of an example process for production of smelter flux, in accordance with one or more embodiments.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of lead reclamation from cathode ray tubes. However, the embodiments are not so limited. It is appreciated that the embodiments may be adapted for use in various other reclamation applications, which may be improved by the disclosed structures, arrangements and/or methods. For example, it is contemplated that some various arrangement may be configured for reclamation of other heavy metals, non-heavy metals, and/or rare earths from various recycled inputs. The system is merely shown and described as being used in the context of lead reclamation from cathode ray tubes for ease of description and as one of countless examples.

System 10:

With reference to the figures, a system and method for reclamation of leaded glass 10 (or simply system 10) are presented. System 10 is formed of any suitable size, shape and design and is configured to facilitate the reclamation of leaded glass in an improved manner.

In the arrangement shown, as one example, system 10 includes: dust collector 12, box tipper 14, surge hopper with feeder 16, first incline conveyor 18, trommel feed conveyor 20, trommel 22, trommel fines conveyor 24, trommel fines discharge conveyor 26, trommel fines treatment conveyor 28, drag chain conveyor 30, pulverizer 32, pulverizer screw conveyor 34, under magnet belt conveyor 36, overhead belt magnet separator 38, smelter flux lead removal reversing conveyor 40, and lead removal processing line 41 including spanner conveyor 42, second incline conveyor feed conveyor 44, second incline conveyor 46, ball mill feed conveyor 48, ball mill 50, first sump conveyor 52, second sump conveyor 54, glass weigh conveyor 56, glass treatment feeder 58, glass discharge conveyor 60, glass collection conveyor 62, electrolysis machine 64, electrolysis rectifier 66, briquette machine feed conveyor 68, and/or briquette machine 70, among other components, pieces, systems and features.

In the arrangement shown, as one example, system 10 is used to recycle or reclaim lead from leaded glass from televisions or monitors 72.

Not Limited to Cathode Ray Tubes:

Notably, and to be clear, system 10 is not limited to use with only leaded glass from televisions or monitors 72. Instead, reference to televisions or monitors 72 as a feed stock for system 10 is only one of countless potential feed stocks for system 10. The use of televisions or monitors 72 as a feed stock for system 10 is however a prominent potential use of the system 10 and serves as a good example of use of system 10. However, again, use of system 10 in association with televisions or monitors 72 is only one of countless examples. It is hereby contemplated that system 10 may be used in association with any glass having constituent components therein such as decorative glass, instrument glass, protective glass, other cathode ray tubes, or any other form of glass or glass-including component. It is also contemplated that system 10 may be used with flat panel displays such as televisions or monitors (such as volatile or static flat panel displays, including liquid crystal displays, liquid crystal displays with light-emitting diode backlighting, plasma panels, electroluminescent panels, organic light-emitting diodes, quantum dot light emitting diodes, or any other flat panel display or other electronic display) or any other electronic device for that matter, and lighting products and solar panels.

Not Limited to Lead:

Notably, and to be clear, system 10 is not limited to use with only leaded glass. Instead, reference to the removal of lead (Pb) from glass is only one of countless potential metals or contaminants or constituent components that may be removed by the use of system 10. It is hereby contemplated that system 10 may be used to remove any other contaminant or constituent component such as other metals, other heavy metals or any other component, material, element and/or molecule. This may be in addition to the removal of lead, or separate from removing lead.

Televisions or Monitors 72:

In the arrangement shown, as one example, system 10 is used to reclaim lead and other heavy metals from glass from televisions or monitors 72. Televisions or monitors 72 are formed of any suitable size, shape and design. In the arrangement shown, as one example televisions or monitors 72 include a cathode ray tube 74, electronic components 76 a housing 78 as well as other components.

Cathode Ray Tube: In the arrangement shown, as one example, televisions or monitors 72 include a cathode ray tube 74 (or CRT 74). Cathode ray tube 74 is formed of any suitable size, shape and design and is configured to project an image on the screen of the cathode ray tube 74. Conventionally, a cathode ray tube 74 is a vacuum tube that contains one or more electron guns and a phosphorescent screen, and is used to display images. Cathode ray tubes 74 modulate, accelerate, and deflect electron beams onto the screen to create the images. The images may represent electrical waveforms (oscilloscope), pictures (television, computer monitor), radar targets, or other phenomena. However, many other forms of cathode ray tubes 74 exist.

Electronic Components 76: In the arrangement shown, as one example, televisions or monitors 72 include electronic components 76. Electronic components 76 are formed of any suitable size, shape and design and are configured to facilitate the operation of televisions or monitors 72 and cathode ray tubes 74. As examples, electronic components 76 of televisions or monitors 72 may include tuners, coils, cathodes, anodes, switches, wiring, controllers, fans, antennas, and the like components that work in concert with one another to facilitate operation of the television or monitor 72.

Housing 78: In the arrangement shown, as one example, televisions or monitors 72 include housing 78. Housing 78 is formed of any suitable size, shape and design and is configured to house, hold, support and protect the cathode ray tube 74 and electronic components 76 of television or monitor 72. Housing 78 may be formed of plastic, metal, wood, composite or any other material or combination thereof. Housing 78 is configured to provide structural support for television or monitor 72 and protect the fragile cathode ray tube 74 and electronic components 76 housed within housing 78.

Dismantling of Television or Monitor 72:

In the arrangement shown, as one example, an initial step in the process of using system 10 is the televisions or monitors 72 are dismantled. As one example, televisions or monitors 72 are dismantled by removing housing 78 from around cathode ray tube 74. Next, the electronic components 76 are removed from housing 78 as well as from cathode ray tube 74. It is worth noting, that the constituent parts, that is the housing 78 and electronic components 76, may very well be valuable themselves and worth recycling once they are separated for their inherent value and usefulness.

In addition, many televisions or monitors 72 do not have lead in the glass within the screen-portion 75 of the television or monitor 72. As such, in some arrangements, the screen-portion 75 may be separated from the rearward-portion of the cathode ray tube 74.

Glass Input 80:

Once the housing 78 and electronic components 76 are removed from cathode ray tube 74, to the extent possible, and the screen 75 is removed, the remaining portion of the cathode ray tube 74 is then used as the glass input 80 or feed stock for system 10.

In the arrangement shown, as one example, cathode ray tube 74 which forms glass input 80 is formed of pieces of glass having a glass component 82 as well as a lead component and/or heavy metal component 84. In the arrangement shown, as one example, glass component 82 is largely formed of silicon dioxide (SiO₂). In the arrangement shown, as one example, lead component and/or heavy metal component 84 is formed of lead oxide (PbO). In the arrangement shown, the lead oxide (PbO) of lead component and/or heavy metal component 84 is suspended in a matrix of silicon dioxide (SiO₂) of glass component 82.

In the arrangement shown, as one example, the glass input 80 of cathode ray tube 74 may include a coating 86. This coating 86 may be on the interior surface of glass input 80. This coating 86 may be on the exterior surface of glass input 80. This coating 86 may be on the interior surface as well as the exterior surface of glass input 80. This coating 86 is configured to facilitate the operation of cathode ray tube 74.

In one arrangement, cathode ray tubes 74 may be left whole as they enter the system 10 as glass input 80. In another arrangement, cathode ray tubes 74 may be broken into smaller pieces, of desired average size, as they enter the system 10 as glass input 80. In one arrangement, glass input 80 is broken down to pieces having an average maximum size of 3″ to 8″. However. any other size range is hereby contemplated for use.

Dust Collector:

In the arrangement shown, as one example, system 10 includes a dust collector 12. Dust collector 12 is formed of any suitable size, shape and design and is configured to capture or expel dust generated by operating the system 10. In the arrangement shown, as one example, dust collector 12 includes an air handling unit including fans, motors, ductwork, and filters among other components. In the arrangement shown, as one example, dust collector 12 produces a negative pressure throughout the components of the system 10 so as to prevent dust generated from the system 10 from escaping during operation. In one arrangement, dust collector 12 is started in advance of processing glass input 80 through the system 10 and continues for a period of time after processing glass input 80 through the system 10 has finished so as to ensure dust generated during operation is fully captured. In one arrangement, dust collector 12 is connected to all of the dry, or dust generating components of the system 10, which are all components prior to ball mill 50.

Box Tipper:

In the arrangement shown, as one example, system 10 includes a box tipper 14. Box tipper 14 is formed of any suitable size, shape and design and is configured to receive glass input 80 from an operator and then pass that glass input 80 onto downstream components of the system 10. In the arrangement shown, as one example, box tipper 14 receives bulk glass input 80, which in one arrangement is held within large boxes, which may be loaded into box tipper 14 with a forklift or other material handling device. In the arrangement shown, as one example, once box tipper 14 is loaded, the loaded glass input 80 is closed within a sealed cabinet so as to control fugitive dust that is generated when box tipper 14 is operated. In the arrangement shown, as one example, box tipper 14 tips forward and meters out and/or passes glass input 80 onto surge hopper with feeder 16.

Surge Hopper with Feeder 16:

In the arrangement shown, as one example, system 10 includes a surge hopper with feeder 16. Surge hopper with feeder 16 is formed of any suitable size, shape and design and is configured to receive and meter out glass input 80. In the arrangement shown, as one example, surge hopper with feeder 16 is configured to receive and collect the raw glass input 80 that is dumped from boxes of raw glass input 80 from box tipper 14. In this example arrangement, surge hopper with feeder 16 stores this glass input 80 and meters out the glass input 80 at a desired and consistent rate (which is often regulated in pounds per hour) using a conveyor positioned at the bottom of the surge hopper with feeder 16. In a manner of speaking, surge hopper with feeder 16 receives periodic large dumps of glass input 80 from box tipper 14, surge hopper with feeder 16 stores a quantity of this glass input 80. Then surge hopper with feeder 16 consistently meters out an amount of glass input 80 for use in the process of system 10. In the arrangement shown, as one example, surge hopper with feeder 16 dispenses glass input 80 onto first incline conveyor 18.

First Incline Conveyor 18:

In the arrangement shown, as one example, system 10 includes a first incline conveyor 18. First incline conveyor 18 is formed of any suitable size, shape and design and is configured to receive glass input 80 from surge hopper with feeder 16 and dispense glass input 80 for use in trommel 22. In the arrangement shown, as one example, first incline conveyor 18 is formed of a conveying device, such as a belt, drag chain, auger, bucket elevator, or the like, or any other material handling system. In the arrangement shown, as one example, first incline conveyor 18 elevates glass from the output of surge hopper with feeder 16 to the trommel feed conveyor 20 that loads trommel 22.

Trommel Feed Conveyor 20:

In the arrangement shown, as one example, system 10 includes a trommel feed conveyor 20. Trommel feed conveyor 20 is formed of any suitable size, shape and design and is configured to receive glass input 80 from first incline conveyor 18 and dispense glass input 80 for use in trommel 22. In the arrangement shown, as one example, trommel feed conveyor 20 is formed of a conveying device, such as a belt, drag chain, auger, hopper, gate, bucket elevator or the like, or any other material handling system. In the arrangement shown, as one example, trommel feed conveyor 20 feeds glass input 80 into the inlet end 90 of trommel 22 for processing.

Trommel 22:

In the arrangement shown, as one example, system 10 includes a trommel 22. Trommel 22 is formed of any suitable size, shape and design and is configured to remove coating 86 from glass input 80. In the arrangement shown, as one example, trommel 22 is formed of an elongated cylinder 88 having an inlet end 90 and an outlet end 92 and is formed, at least in-part, of a perforated material 94.

In the arrangement shown, as one example, glass input 80 is loaded into the inlet end 90 of cylinder 88 of trommel 22 by trommel feed conveyor 20. A depth of glass input 80 is maintained within cylinder 88 as cylinder 88 rotates. The glass input 80 contained within cylinder 88 as cylinder 88 rotates causes mechanical interaction of the glass input 80 with itself, as well as with the walls and features of cylinder 88, which causes abrasion and the removal of coating 86 on the surface of glass input 80.

As trommel 22 is operated, the coating 86 removed from the surface of glass input 80, as well as any other fines or other particulate material generated during operation of trommel 22 (collectively called “fines 95”), passes through openings in perforated material 94 of cylinder 88 thereby allowing the fines 95 to escape cylinder 88 of trommel 22. However, these fines 95 are captured by an exterior housing 96 that surrounds cylinder 88. As such, fines 95 are captured in the space between the space between cylinder 88 and exterior housing 96. These fines 95 are discharged from trommel 22 by trommel fines conveyor 24 which is positioned on the lower side of trommel 22. As trommel 22 is operated, pieces of glass input 80 that are too large to pass through the openings in perforated material 94 pass from the inlet end 90 to the outlet end 92 and are discharged by drag chain conveyor 30.

In the arrangement shown, as one example, once the system 10 reaches operational equilibrium, glass input 80 is metered out of trommel 22 at about the same rate glass input 80 is metered into trommel 22. The depth of glass input 80 within trommel 22 is controlled by the input rate of trommel feed conveyor 20 as well as the size, shape and manner of operation of the opening at the outlet end 92 of cylinder 88. In one arrangement a gate or other meter device is used to control the depth of glass input 80 within trommel 22. In the arrangement shown, as one example, drag chain conveyor 30 carries away the processed glass input 80 as it exits the outlet end 92 of cylinder 88 of trommel 22.

In one arrangement, trommel 22 is positioned at a relatively level orientation. That is, in this arrangement, inlet end 90 and outlet end 92 are positioned at about the same vertical height. In this arrangement, it is essentially the flow of glass input 80 into the inlet end 90 of trommel 22 that causes the outflow of glass input 80 out of the outlet end 92 by raising the depth of glass input 80 within trommel 22. In another arrangement, trommel 22 is positioned in an angled relation wherein the outlet end 92 is positioned slightly below the inlet end 90 so as to provide some gravitational assistance to the flow of glass input 80 through trommel 22. In one arrangement, as one example, trommel 22 is approximately twenty-four feet long and the outlet end 92 is approximately one to two inches below the inlet end 90.

In one arrangement, as one example, cylinder 88 has a first section 98 that has a solid sidewall that does not let the passage of fines 95 through the solid wall. In one arrangement that has been tested with success, the first section 98 extends approximately two-thirds to three-quarters of the length of cylinder 88. However, any other range or length of the solid first section 98 is hereby contemplated, such as 10%, 20%, 30%, 40%, 50%, 60%, 70%, 80%, 90% or any length or range there between.

In this arrangement, a second section 100 is positioned downstream of the first section 98. Unlike the first section 98, which has a solid wall that does not let the passage of fines 95 through the sidewall of the cylinder 88, the second section 100 includes perforated material 94 that allows the passage of fines 95 through the openings in the perforated material 94. This second section 100 occupies the balance of the length of cylinder 88 that first section 98 does not occupy. The larger the perforations in perforated material 94 the larger the fines 95 that are allowed to escape.

In one arrangement, as one example, cylinder 88 has a collar 101 positioned at the intersection of the first section 98 and the second section 100. In one arrangement, collar 101 includes a solid wall and an opening at its approximate center. In this arrangement, the solid wall of collar 101 prevents the passage of glass input 80 and fines 95 through the solid wall, which retains the glass input 80 and fines 95 within first section 98 of cylinder 88. In one arrangement, this collar 101 extends inward from the interior wall of cylinder 88 at the intersection of the first section 98 and the second section 100 and includes a cylindrical or circular opening at the center of cylinder 88.

The larger the opening in the collar 101 the shallower the level of glass input 80 and fines 95 that is held within the first section 98. In contrast, the smaller the opening in collar 101 the deeper the level of glass input 80 that is held within the first section 98. Once the system 10 reaches equilibrium, the collar 101 serves essentially as a dam that holds back the level of glass input 80 and fines 95. As glass input 80 enters the inlet end 90 of cylinder 88 of trommel 22 this raises the level of glass input 80 and fines 95 within the first section 98 thereby causing glass input 80 to pour over the opening in the collar 101 at the down-stream end of the first section 98 of cylinder 88.

In one arrangement, a similar and/or identical collar 101 is positioned at the inlet end 90 of cylinder 88 which serves a similar function, which is to retain glass input 80 and fines 95 within cylinder 88. In one arrangement, a similar and/or identical collar 101 is positioned at the outlet end 92 of cylinder 88 which serves a similar function, which is to retain glass input 80 and fines 95 within cylinder 88.

As the cylinder 88 rotates, the glass input 80 that is held within the first section 98 is constantly tumbled within the first section 98 of the cylinder 88. In one arrangement, a plurality of paddles 103 extend inward from the interior surface of the first section 98 of cylinder 88. These paddles 103 serve to carry glass input 80 upward as cylinder 88 rotates. The glass input 80 falls off of the paddles 103 as the paddles 103 reach the upper portion of the rotation. This action causes glass input 80 constrained within the first section 98 of the cylinder 88 to constantly be in motion, causing the particles and pieces of glass input 80 to constantly engage one another. As the particles and pieces of glass input 80 engage one another this mechanical action causes coating 86 to be removed from glass input 80. As the coating 86 is removed from glass input 80, the coating 86 becomes fines 95 along with broken smaller pieces of the glass input 80. This mechanical action also has the effect of breaking the glass input 80 into smaller particulate material size.

When the glass input 80 passes into the second section 100 of cylinder 88 the fines 95 contained within the particles and pieces of glass input 80 are allowed to pass through the openings in the perforated material 94 of the second section 100 while the larger pieces of glass input 80 are retained within the second section 100. These fines 95 are captured in the space between cylinder 88 and exterior housing 96 of trommel 22. These fines 95 are conveyed by trommel fines conveyor 24 to trommel fines discharge conveyor 26. The pieces of glass input 80 that are too large to filter through the perforated material 94 spill out the outlet end 92 of cylinder 88 past collar 101 and onto drag chain conveyor 30.

It has been tested that the fines 95 content may range anywhere between 5% to 25% of the weight of the glass input 80, however any other range is hereby contemplated. The longer the glass input 80 remains in the trommel 22 the more interaction there is between the pieces of glass input 80 and therefor more small particles break off the larger pieces of the glass input 80. As such, the longer the glass input 80 remains within the trommel 22 the greater the amount of fines 95.

In one arrangement, glass input 80 that enters trommel 22 has an average maximum size of 3″ to 8″. In one arrangement, glass input 80 that enters trommel 22 has an average maximum size that is less than the entry size of 3″ to 8″. In some arrangements the average maximum size of the exiting glass input 80 may be reduced from 10% to 90% depending on operational characteristics such as of the system 10 such as dwell time within trommel 22, perforation size of perforated material 94, feed rate of trommel 22, length of trommel 22, size of trommel 22, among countless other variables. In one arrangement, that has been tested with success, the average maximum size of the exiting glass input 80 is reduced by 50% as compared to the average maximum size of the entering glass input 80. In one arrangement, trommel 22 operates at approximately 6,000 lbs/hr of throughput.

Trommel Fines Conveyor 24:

In the arrangement shown, as one example, system 10 includes a trommel fines conveyor 24. Trommel fines conveyor 24 is formed of any suitable size, shape and design and is configured to collect and discharge the fines 95, and removed coating 86, that are generated during operation of trommel 22 and screened from glass input 80 through perforated material 94 of second section 100. In the arrangement shown, as one example, trommel fines conveyor 24 is formed of a conveying device, such as a belt, drag chain, auger, hopper, gate, bucket elevator or the like or any other material handling device or system. In one arrangement, as one example, trommel fines conveyor 24 extends along the entire length of the lower side of trommel 22. In another arrangement, trommel fines conveyor extends only a portion of the lower side of trommel 22, such as below the portion having perforated material 94 in second section 100. Trommel fines conveyor 24 receives fines 95 and removed coating 86 that is captured between the exterior of cylinder 88 and the interior of exterior housing 96 of trommel 22.

In the arrangement shown, as one example, trommel fines conveyor 24 feeds fines 95 into trommel fines discharge conveyor 26 for further processing.

Trommel Fines Discharge Conveyor 26:

In the arrangement shown, as one example, system 10 includes a trommel fines discharge conveyor 26. Trommel fines discharge conveyor 26 is formed of any suitable size, shape and design and is configured to receive the removed coating 86 and other discharged fines 95 that are generated during operation of trommel 22 from trommel fines conveyor 24. In the arrangement shown, as one example, trommel fines discharge conveyor 26 is formed of a conveying device, such as a belt, drag chain, auger, hopper, gate, bucket elevator or the like or any other material handling device or system. In one arrangement, as one example, trommel fines discharge conveyor 26 is an auger as the auger-action facilitates thorough mixing of the fines 95 with a reagent 102, as is further described herein, which serves to neutralize the leaching of lead or other heavy metals contained within the fines 95.

In the arrangement shown, as one example, trommel fines discharge conveyor 26 deposits the fines 95 and mixed reagent 102 into a bulk storage container 104 at the outward end of trommel fines discharge conveyor 26. In some arrangements, a reversible secondary conveyor is positioned at the outward end of the trommel fines discharge conveyor 26 so as to facilitate loading of two bulk storage containers 104. This allows one bulk storage container 104 to be filled while the other bulk storage container 104 is being removed and replaced. This facilitates a continuous flow operation and increases throughput.

Trommel Fines Treatment Conveyor 28:

In the arrangement shown, as one example, system 10 includes a trommel fines treatment conveyor 28. Trommel fines treatment conveyor 28 is formed of any suitable size, shape and design and is configured to convey and dispense reagent 102 into the stream of fines 95 that are discharged by trommel fines discharge conveyor 26 so as to neutralize the leaching of lead or other heavy metals within the fines 95. In the arrangement shown, as one example, trommel fines treatment conveyor 28 is formed of a conveying device, such as a belt, drag chain, auger, hopper, gate, bucket elevator or the like or any other material handling device or system. In one arrangement, as one example, trommel fines treatment conveyor 28 is an auger or belt receives reagent 102 on one end from a metering system connected to a hopper 106 that holds a bulk amount of reagent 102. Trommel fines treatment conveyor 28 then dispenses this reagent 102 into the stream of fines through an input point 108 in the housing around trommel fines discharge conveyor 26.

In this way, trommel fines treatment conveyor 28 injects or dispenses reagent 102 into the stream of fines through input point 108 well before fines 95 are deposited into bulk storage container 104. Injecting reagent 102 into the stream of fines 95 at the input point 108 ensures that reagent 102 is well mixed with the fines 95 so as to ensure adequate coverage and effectiveness.

In one arrangement a weigh system 110 is associated with trommel fines discharge conveyor 26 and trommel fines treatment conveyor 28. Weigh system 110 is formed of any suitable size, shape and design and is configured to weigh the amount of fines 95 that exits trommel 22. In one arrangement, weigh system 110 weighs the fines 95 as they exit trommel 22 on trommel fines discharge conveyor 26. Based on the measured weight from weigh system 110 the metered rate of hopper 106 is adjusted so that the amount of reagent 102 applied to the outflow of fines 95 within trommel fines discharge conveyor 26 is adjusted so as to ensure an optimum amount of reagent 102 is applied to fines 95 at all times. In this way, the inclusion of a weigh system 110 is helpful for optimizing the process and ensuring enough reagent 102 is used while also ensuring that too much reagent 102 is not used. In one arrangement, approximately 7% by weight of reagent 102 is added to the flow of fines 95. However, any other range of weight is hereby contemplated for use, from 1% by weight up to 30% by weight, as well as any other range within that range.

Reagent 102:

In one arrangement, as one example, reagent 102 is a reagent blend that is developed to reduce the mobility of lead and heavy metals contained within contaminated materials, such as fines 95. The addition of reagent 102 prevents leaching of lead and heavy metals from contaminated materials, such as fines 95. In one arrangement, the addition of reagent 102 causes the lead or heavy metal in the fines 95 to form insoluble salts with the reagent 102. This stabilizes the lead or heavy metal within the fines 95 and prevents their leaching. In one arrangement, “Free Flow” reagent is used manufactured by Free Flow Technologies, Ltd. Having an address of 4920 Forest Hills Rd, Suite 200, Loves Park, Ill. 61111. In one arrangement, “Free Flow 300” has been tested with success.

In one arrangement, reagent 102 is a blend of components including:
Phosphate compounds (Ca(H₂PO₄)2H₂O),
Calcium Oxide (CaO),
Sulfur Trioxide (SO₃),
Silicon Dioxide (SiO₂),
Aluminum Oxide (Al₂O₃),
Iron Oxide (Fe₂O₃),
Sodium Bicarbonate (NaHCO₃),
Magnesium Oxide MgO).

However, any other form of a reagent 102 is hereby contemplated for use including Free Flow 100, Free Flow 200 or any other form of a reagent including custom blends. In addition, any other chemical composition is hereby contemplated for use as reagent 102.

In one arrangement, the application of reagent 102 to fines 95 allows fines 95 to pass the TCLP environmental test. TCLP stands for Toxicity Characteristic Leaching Procedure (TCLP), which is a soil sample extraction method for chemical analysis employed as an analytical method to simulate leaching through a landfill. The testing methodology is used to determine if a waste is characteristically hazardous, i.e., classified as one of the “D” listed wastes by the U.S. Environmental Protection Agency (EPA). The extract is analyzed for substances appropriate to the protocol.

In the TCLP procedure the pH of the sample material is first established, and then leached with an acetic acid/sodium hydroxide solution at a 1:20 mix of sample to solvent. For example, a TCLP jug may contain 100 g of sample and 2000 mL of solution. The leachate mixture is sealed in extraction vessel for general analytes, or possibly pressure sealed as in zero-headspace extractions (ZHE) for volatile organic compounds and tumbled for 18 hours to simulate an extended leaching time in the ground. It is then filtered so that only the solution (not the sample) remains and this is then analyzed. Testing has shown that prior to the application of reagent 102 to fines 95, fines 95 would not pass the TCLP test. Testing has shown that after the application of reagent 102 to fines 95, fines 95 pass the TCLP test. As such, prior to the application of reagent 102 to fines 95, fines 95 is classified as a hazardous material (i.e. classified as one of the “D” listed wastes by the U.S. Environmental Protection Agency (EPA). As such, after the application of reagent 102 to fines 95, fines 95 is not classified as a hazardous material (i.e. classified as one of the “D” listed wastes by the U.S. Environmental Protection Agency (EPA).

Drag Chain Conveyor 30:

In the arrangement shown, as one example, system 10 includes a drag chain conveyor 30. Drag chain conveyor 30 is formed of any suitable size, shape and design and is configured to convey treated glass input 80 from the outlet end 92 of trommel 22 to pulverizer 32. In the arrangement shown, as one example, drag chain conveyor 30 is formed of a conveying device, such as a belt, drag chain, auger, hopper, gate, bucket elevator or the like or any other material handling device or system. In one arrangement, as one example, drag chain conveyor 30 carries glass input 80 from outlet end 92 of cylinder 88, after it has been treated by trommel 22, to the input of pulverizer 32.

Pulverizer 32:

In the arrangement shown, as one example, system 10 includes a pulverizer 32. Pulverizer 32 is formed of any suitable size, shape and design and is configured to reduce the size of glass input 80 after glass input 80 exits trommel 22 and before glass input 80 enters ball mill 50. Pulverizer 32 may be formed of any mechanically acting device that reduces the size of glass input 80 and may be formed of a press, crusher, grinder, stomper, a hammering device, and the like. In one or more arrangements, as one example, pulverizer 32 includes one or more shafts that extend through the pulverizer 32 and include a plurality of hammers thereon. As the one or more shafts rotate, so rotate the hammers. As the hammers rotate, they engage the pieces of glass input 80 thereby breaking the glass input 80 into smaller particulate size.

In one arrangement, holes in the bottom of pulverizer 32 allow pieces of glass input 80, that are reduced to a desired size, to pass through the holes and out pulverizer 32. In one arrangement, the average maximum size of glass input 80 that exits pulverizer 32 is one inch, however any other size is hereby contemplated for use. In the arrangement shown, as one example, as glass input 80 passes through holes in the bottom of glass input 80 after they have been suitably reduced in size, the glass input 80 is fed into pulverizer screw conveyor 34.

Pulverizer Screw Conveyor 34:

In the arrangement shown, as one example, system 10 includes a pulverizer screw conveyor 34. Pulverizer screw conveyor 34 is formed of any suitable size, shape and design and is configured to convey treated glass input 80 that passes through the holes in the bottom of pulverizer 32 to the under magnet belt conveyor 36 and overhead belt magnet separator 38. In the arrangement shown, as one example, pulverizer screw conveyor 34 is formed of a conveying device, such as a belt, drag chain, auger, hopper, gate, bucket elevator or the like or any other material handling device or system. In one arrangement, a screw conveyor or auger has been tested with success as pulverizer screw conveyor 34. In one arrangement, as one example, pulverizer screw conveyor 34 carries glass input 80 from pulverizer 32, after it has been treated by pulverizer 32, to the input of under magnet belt conveyor 36 and overhead belt magnet separator 38.

Under Magnet Belt Conveyor 36 and Overhead Belt Magnet Separator 38:

In the arrangement shown, as one example, system 10 includes an under magnet belt conveyor 36 and an overhead belt magnet separator 38. Under magnet belt conveyor 36 and overhead belt magnet separator 38 are formed of any suitable size, shape and design and are configured to receive treated glass input 80 that passes through the holes in the bottom of pulverizer 32 from pulverizer screw conveyor 34 and treat this glass input 80 to remove any ferrous, metallic and/or other contaminants.

In the arrangement shown, as one example, under magnet belt conveyor 36 is formed of a conveying device, such as a belt, drag chain, auger, hopper, gate, bucket elevator or the like or any other material handling device or system. In one arrangement, under magnet belt conveyor 36 carries glass input 80 underneath the overhead belt magnet separator 38.

In the arrangement shown, as one example, overhead belt magnet separator 38 is formed of a conveying device, such as a belt, drag chain, auger, hopper, gate, bucket elevator or the like or any other material handling device or system that also serves to remove ferrous, metallic and/or other contaminants from glass input 80 that are not formed of glass. In one arrangement, overhead belt magnet separator 38 includes a belt or other conveying device and a magnetic device that magnetically attracts ferrous and other magnetic materials.

When activated, overhead belt magnet separator 38 pulls and/or lifts ferrous, metallic and/or other contaminant materials out of glass input 80 as glass input 80 travels on under magnet belt conveyor 36 below overhead belt magnet separator 38. In one arrangement, overhead belt magnet separator 38 includes a powerful electromagnet that pulls small contaminant pieces out of glass input 80. In one arrangement, overhead belt magnet separator 38 includes a belt that is positioned in approximate perpendicular alignment to the belt of under magnet belt conveyor 36. In this way, overhead belt magnet separator 38 removes ferrous, metallic and/or other contaminants from the stream of glass input 80 and carries these ferrous, metallic and/or other contaminants to the side of under magnet belt conveyor 36. These ferrous, metallic and/or other contaminants are deposited into a bulk storage container 104 for removal and resale and/or disposal and/or other industrial purposes.

In one arrangement, under magnet belt conveyor 36 conveys glass input 80 to smelter flux lead removal reversing conveyor 40, when present. Alternatively, under magnet belt conveyor 36 conveys glass input to spanner conveyor 42.

Smelter Flux Lead Removal Reversing Conveyor 40:

In the arrangement shown, as one example, system 10 includes a smelter flux lead removal reversing conveyor 40. Smelter flux lead removal reversing conveyor 40 is formed of any suitable size, shape and design and is configured to convey treated glass input 80 that passes through under magnet belt conveyor 36 and overhead belt magnet separator 38 to a bulk storage container 104 for removal and use as a smelter flux and/or for other industrial uses.

In the arrangement shown, as one example, smelter flux lead removal reversing conveyor 40 is formed of a conveying device, such as a belt, drag chain, auger, hopper, gate, bucket elevator or the like or any other material handling device or system. In one arrangement, as one example, smelter flux lead removal reversing conveyor 40 carries glass input 80 from under magnet belt conveyor 36 and overhead belt magnet separator 38 to be deposited into a bulk storage container 104 when operated in a first direction. In one arrangement, as one example, smelter flux lead removal reversing conveyor 40 carries glass input 80 from under magnet belt conveyor 36 and overhead belt magnet separator 38 to be deposited into spanner conveyor 42 for processing in a lead removal processing line 41 when operated in a second direction, which is opposite the first direction.

Notably, smelter flux lead removal reversing conveyor 40 is only used when it is desired to remove glass input 80 at this point in the process for use as a smelter flux or for other industrial uses. Alternatively, a spanner conveyor 42 is used to transport glass input 80 to second incline conveyor feed conveyor 44.

Spanner Conveyor 42:

In the arrangement shown, as one example, system 10 includes a spanner conveyor 42. Spanner conveyor 42 is formed of any suitable size, shape and design and is configured to convey glass input 80 from smelter flux lead removal reversing conveyor 40, when present, or alternatively from under magnet belt conveyor 36 when smelter flux lead removal reversing conveyor 40 is not present, to second incline conveyor feed conveyor 44. In the arrangement shown, as one example, spanner conveyor 42 is formed of a conveying device, such as a belt, drag chain, auger, hopper, gate, bucket elevator or the like or any other material handling device or system. In one arrangement, as one example, spanner conveyor 42 carries glass input 80 from smelter flux lead removal reversing conveyor 40 or under magnet belt conveyor 36 to second incline conveyor feed conveyor 44.

Second Incline Conveyor Feed Conveyor 44:

In the arrangement shown, as one example, system 10 includes a second incline conveyor feed conveyor 44. Second incline conveyor feed conveyor 44 is formed of any suitable size, shape and design and is configured to convey glass input 80 from spanner conveyor 42 to second incline conveyor 46. In the arrangement shown, as one example, second incline conveyor feed conveyor 44 is formed of a conveying device, such as a belt, drag chain, auger, hopper, gate, bucket elevator or the like or any other material handling device or system. In one arrangement, as one example, second incline conveyor feed conveyor 44 carries glass input 80 from spanner conveyor 42 and deposits glass input 80 to second incline conveyor 46.

Second Incline Conveyor 46:

In the arrangement shown, as one example, system 10 includes a second incline conveyor 46. Second incline conveyor 46 is formed of any suitable size, shape and design and is configured to convey glass input 80 from second incline conveyor feed conveyor 44 to ball mill feed conveyor 48. In the arrangement shown, as one example, second incline conveyor feed conveyor 44 is formed of a conveying device, such as a belt, drag chain, auger, hopper, gate, bucket elevator or the like or any other material handling device or system. In one arrangement, as one example, second incline conveyor 46 carries glass input 80 from second incline conveyor feed conveyor 44 upward until it reaches the operational height for depositing glass input into the higher-positioned ball mill 50. Second incline conveyor 46 deposits glass input into ball mill feed conveyor 48.

Ball Mill Feed Conveyor 48:

In the arrangement shown, as one example, system 10 includes a ball mill feed conveyor 48. Ball mill feed conveyor 48 is formed of any suitable size, shape and design and is configured to convey glass input 80 from second incline conveyor 46 to ball mill 50. In the arrangement shown, as one example, ball mill feed conveyor 48 is formed of a conveying device, such as a belt, drag chain, auger, hopper, gate, bucket elevator or the like or any other material handling device or system. In one arrangement, as one example, ball mill feed conveyor 48 carries glass input 80 from second incline conveyor 46 to be deposited in the inlet 116 of ball mill 50.

Ball Mill 50:

In the arrangement shown, as one example, system 10 includes a ball mill 50. Ball mill 50 is formed of any suitable size, shape and design and is configured pulverize glass input 80 into a fine powder while exposing the pulverized glass input particulate matter to a chemical solution (e.g., a electrolytic fluid 112) which strips lead and/or other heavy metals or contaminants from the surface of the particles of the pulverized glass input particulate matter thereby reducing the lead and/or other heavy metal or contaminant content of the pulverized glass input particulate matter.

In the arrangement shown, as one example, ball mill 50 includes a cylinder 114 that is generally cylindrical in shape and extends a length from an inlet end 116 to an outlet end 118 and includes a hollow interior 120. In the arrangement shown, hollow interior 120 holds a plurality of balls 122. In one arrangement, balls 122 are generally spherical in shape. In one arrangement, balls 122 are formed of a durable material such that when balls 122 engage glass input 80 the glass input 80 is broken down into smaller particulate size. In some various arrangements, such durable material for balls 122 may include, for example, various metals and/or various ceramic material (e.g., alumina ceramic, beryllium oxide ceramic, zirconia ceramic, silicon carbide ceramic, silicon nitride ceramic, and/or fiber-reinforced ceramics). In one arrangement, balls 122 range in size from ¾″ to 3″ inches in diameter, however any other size, shape and design for balls 122 is hereby contemplated for use.

In the arrangement shown, as one example, the interior surface of cylinder 114 is covered with a layer of tiles 124. Tiles 124 are formed of any suitable size, shape and design and are configured to protect the interior surface of cylinder 114 and facilitate the pulverization of glass input into pulverized glass input particulate matter. In one arrangement, the entire interior surface of cylinder 114 is lined with tiles 124.

In one arrangement, glass input 80 is loaded into the inlet end 116 of cylinder 114 of ball mill 50 by ball mill feed conveyor 48. In addition, electrolytic fluid 112 is injected, poured or otherwise dispensed directly into the inlet end 116 of cylinder 114 of ball mill 50. Alternatively, electrolytic fluid 112 is injected, poured or otherwise dispensed onto the glass input 80 while glass input 80 is conveyed by ball mill feed conveyor 48 such that glass input 80 and electrolytic fluid 112 enter inlet end 116 of cylinder 114 simultaneously. It is hereby contemplated that electrolytic fluid 112 may enter ball mill 50 by any other manner, method or means.

A depth of glass input 80 is maintained within cylinder 114 of ball mill 50 as cylinder 114 rotates. As cylinder 114 rotates, glass input 80 as well as balls 122 contained within cylinder 114 move and engage one another thereby causing mechanical interaction of the glass input 80 with itself as well as with balls 122 as well as with the walls and features of cylinder 114. This mechanical interaction with glass input 80 causes glass input 80 to be pulverized or broken down in size to form pulverized glass input particulate matter of a desirable size.

In one arrangement, glass input 80 enters cylinder 114 having an average size of approximately 1″, however any other size or range of sizes is hereby contemplated for use. Specifically, any size within the range of 3″ to 0.1″ for the average size of glass input 80 entering cylinder 114 is hereby contemplated for use. In one arrangement, glass input 80 exits cylinder 114 having an average size of approximately 0.003″, however any other size or range of sizes is hereby contemplated for use. Specifically, any size within the range of 0.1″ to 0.0001″ for the average size of glass input 80 exiting cylinder 114 is hereby contemplated for use. Other ranges that are contemplated for the average size of glass input 80 exiting cylinder 114 include the following ranges: 0.0035″ to 0.0025″; 0.004″ to 0.002″; 0.005″ to 0.001″; 0.006″ to 0.0005″; 0.0075″ to 0.00025″; 0.0075″ to 0.0001″; 0.0075″ to 0.001″; 0.01″ to 0.0001″; 0.01″ to 0.001″; 0.1″ to 0.001″; or any other range is hereby contemplated for use.

In one arrangement, glass input 80 goes into ball mill 50 having a granular consistency and exits ball mill 50 having the consistency of a powder (such as flour for example), albeit a wet powder due to the exposure to electrolytic fluid 112.

As ball mill 50 is operated, glass input 80 is pulverized or otherwise broken down mechanically into pulverized glass input particulate matter having a small particulate size, that equivalent of a powder or flour. Breaking glass input 80 down into this small particulate size has the effect of exposing molecules and/or atoms of lead component and/or heavy metal component 84 contained or suspended or sealed within the glass component 82 of glass input with a surface of the pulverized glass input particulate matter. That is, by breaking glass input 80 down into this small particulate size of pulverized glass input particulate matter this causes molecules and/or atoms of lead component and/or heavy metal component 84 to be exposed to the surface of the smaller particles of pulverized glass input particulate matter.

By exposing the lead component and/or heavy metal component 84 with a surface of the pulverized glass input particulate matter this enables electrolytic fluid 112 to interact with the lead component and/or heavy metal component 84. When electrolytic fluid 112 interacts with the lead component and/or heavy metal component 84 of the particles of pulverized glass input particulate matter this allows electrolytic fluid 112 to strip, dissolve or otherwise remove the exposed lead component and/or heavy metal component 84 from the particles of pulverized glass input particulate matter. This process removes the lead component and/or heavy metal component 84 while leaving the glass component 82 behind. That is, the lead component and/or heavy metal component 84 is stripped, dissolved or otherwise removed from the glass component 82 that is left behind.

The result is, the glass input 80 goes into ball mill 50 having a granular consistency with a high content of lead component and/or heavy metal component 84, and comes out of ball mill 50 having the consistency of powder of flour with minimal, practically zero, lead component and/or heavy metal component 84.

In one arrangement, electrolytic fluid 112 is pumped into ball mill 50 using pump system 126. Electrolytic fluid 112 is pumped by pump system 126 through a fluid conduit system 128. In one arrangement, electrolytic fluid 112 is pumped through a water heater 130 which warms electrolytic fluid 112 to a desired operational temperature. It has been tested that the higher the operational temperature the faster and the more-thorough the removal of lead component and/or heavy metal component 84 from pulverized glass input particulate matter. While it is desirable to maximize the removal of lead component and/or heavy metal component 84 by increasing the temperature of electrolytic fluid 112 to higher and higher temperatures using water heater 130, the higher the temperature of electrolytic fluid 112 the more dangerous the process becomes due to risk of injury.

As such, while it is desirable to increase the temperature of electrolytic fluid 112 to a high temperature for throughput reasons and to ensure a thorough chemical reaction, for safety purpose it is desirable to maintain the temperature of electrolytic fluid 112 at a reasonable temperature. As such, any range between room temperature and a maximum temperature (which may be the boiling point of electrolytic fluid 112) is hereby contemplated for use. With lower temperatures being safer from a personal standpoint and higher temperatures being better from a throughput standpoint, as a balance between these competing considerations, in one arrangement a temperature range of between 100° F. and 175° F. is hereby contemplated for use. In one arrangement, a temperature range of between 150° F. and 160° F. is contemplated for use.

In one or more arrangements, in addition to or in lieu of heating electrolytic fluid 112 additional heating elements are placed on, around and/or in ball mill 50 so as to increase the operational temperature of ball mill 50. These may be heating coils, heated fluid, radiant heat, heated air, or any other form of heat, heating or a heating element.

In the arrangement shown, as one example, once ball mill 50 reaches operational equilibrium, glass input 80 is metered out of ball mill feed conveyor 48 and into the inlet end 116 of ball mill 50 at about the same rate glass input 80 is metered out of the outlet end 118 of ball mill 50. The depth of glass input 80 within ball mill 50 is controlled by the input rate of trommel ball mill feed conveyor 48 as well as the size, shape and manner of operation of the opening at the outlet end 118 of cylinder 114. In one arrangement a gate or other meter device is used to control the depth of glass input 80 within ball mill 50. In the arrangement shown, as one example, glass input 80, which is in the form of pulverized glass input particulate matter pours out of the outlet end 118 of cylinder 114 and into the reservoir 132 of first sump conveyor 52, which is positioned below the outlet end 118 of cylinder 114 of ball mill 50.

In one arrangement, ball mill 50 is positioned at a relatively level orientation. That is, in this arrangement, inlet end 116 and outlet end 118 are positioned at about the same vertical height. In this arrangement, it is essentially the flow of glass input 80 into the inlet end 116 of ball mill 50 that causes the outflow of glass input 80, which is pulverized glass input particulate matter, out of the outlet end 118 by raising the depth of glass input 80 within ball mill 50. In another arrangement, ball mill 50 is positioned in an angled relation wherein the outlet end 118 is positioned slightly below the inlet end 116 so as to provide some gravitational assistance to the flow of glass input 80 through ball mill 50. In one arrangement, as one example, ball mill 50 is approximately twenty-four feet long and the outlet end 118 is approximately one to two inches below the inlet end 116.

In one arrangement, as one example, cylinder 114 of ball mill 50 includes only a single section that occupies the entire hollow interior 120 of cylinder 114. In this arrangement, glass input 80 and balls 122 are free to move along the entire interior space of ball mill 50. In an alternative arrangement, the hollow interior 120 of ball mill 50 is separated into two or more sections by placing separating collars within the hollow interior 120 of ball mill 50. In this arrangement, each section may have its own size of balls 122 so as to facilitate breaking down glass input 80 into smaller and smaller particulate matter size. As one example, two collars having solid sidewalls and a circular opening at their middle are placed at the approximate ⅓ mark and the approximate ⅔ mark along the length of hollow interior 120, the first section having the largest balls 122 (e.g. 3″ diameter balls), the second section having mid-sized balls 122 (e.g. 2″ diameter balls) and the third section having the smallest balls 122 (e.g. 1″ diameter balls). Any other number of sections is hereby contemplated for use as is any size of balls 122 within each of these sections. In this arrangement, the glass input 80 is increasingly pulverized into smaller and smaller particulate matter size as it moves from one section to the downstream section.

In one arrangement, as one example, cylinder 114 of ball mill 50 has a collar 134 positioned at the intersection of the cylindrical tube that forms the inlet end 116 and the cylindrical tube that forms the outlet end 118. In one arrangement, collar 134 serves to transition from the smaller diameter of inlet end 116 and outlet 118 to the larger diameter of cylinder 114 of ball mill 50. In this arrangement, glass input 80 as well as balls 122 as well as electrolytic fluid 112 are retained within lower portion of cylinder 114 at or below the lower portion of inlet end 116 and/or outlet end 118. That is, the portion of cylinder 114 below the lower edge of inlet end 116 and/or outlet end 118 fills with glass input 80 and electrolytic fluid 112 before glass input 80 and electrolytic fluid 112 begins to flow out the outlet end 118 of cylinder 114.

In one arrangement, to prevent the escape of balls 122 and/or larger pieces of glass input 80 from the hollow interior 120 of cylinder 114 a grate 135 is positioned over the opening of outlet end 118. This grate 135 includes openings that allow pulverized glass input particulate matter as well as electrolytic fluid 112 to pass through the grate 135 while preventing balls 122 and/or larger pieces of glass input 80 from exiting hollow interior 120.

As the cylinder 114 rotates, the glass input 80, electrolytic fluid 112 and balls 122 that is held within the hollow interior 120 of cylinder 114 is constantly tumbled. In one arrangement, a plurality of paddles 103, which are similar to if not identical to paddles 103 described herein with respect to trommel 22, extend inward from the interior surface of the hollow interior 120 of cylinder 114. These paddles 103 serve to carry glass input 80 upward as cylinder 114 rotates. The glass input 80 falls off of the paddles 103 as the paddles 103 reach the upper portion of the rotation. Note the presence of paddles 103 is optional and may not be present within cylinder 114.

This action causes glass input 80, electrolytic fluid 112 and balls 122 constrained within cylinder 114 to constantly be in motion, causing the particles and pieces of glass input 80 to constantly engage one another to be engaged by balls 122 and to be engaged by tiles 124. As the particles and pieces of glass input 80 engage one another, engage balls 122 and engage tiles 124 this mechanical action causes glass input 80 to be pulverized into smaller and smaller particulate material size until the desired size is achieved, which is the pulverized glass input particular matter.

As the glass input 80 is pulverized into smaller and smaller particulate material to the newly formed and smaller particles of glass input 80 are exposed to the electrolytic fluid 112, as well as the heat within cylinder 114, when present. As smaller and smaller particles of glass input 80 are formed this new surface area of these smaller particles is engaged by electrolytic fluid 112 which has the effect of stripping, dissolving or otherwise removing the exposed lead component and/or heavy metal component 84 from the particles of pulverized glass input particulate matter.

The longer the glass input 80 remains in the ball mill 50 the more interaction there is between the pieces of glass input 80 and balls 122 and therefor the smaller the resulting pulverized glass input particulate matter. As such, the longer the glass input 80 remains within the ball mill the smaller the particle size and the greater the amount of removal of lead component and/or heavy metal component 84 until a particle size is reached having a point of diminished returns. As such, in one arrangement it has been tested that particle size of approximately 0.003″ is desirable for operational efficiencies. Particle size below 0.003″ may not result in appreciable removal of lead component and/or heavy metal component 84, and/or may cause other operational problems such as difficulty removing it from electrolytic fluid 112, plugging components and the like.

In the arrangement shown, as one example, cylinder 114 is supported by supports 136 and rotates upon bearings 138.

As ball mill 50 is filled at the inlet end 116, electrolytic fluid 112 and suspended pulverized glass input particulate material flows through grate 135 at the downstream end of cylinder 114 and out the outlet end 118 and into the reservoir 132 of first sump conveyor 52.

First Sump Conveyor 52:

In the arrangement shown, as one example, system 10 includes a first sump conveyor 52. First sump conveyor 52 is a type of settling tank formed of any suitable size, shape and design and is configured to receive electrolytic fluid 112 and suspended pulverized glass input particulate material from ball mill 50 and is configured to allow the suspended pulverized glass input particulate material settle out of the electrolytic fluid 112 so as to allow the pulverized glass input particulate material to be effectively and efficiently separated from the electrolytic fluid 112. In the arrangement shown, as one example, first sump conveyor 52 includes a reservoir 132 that receives and holds a volume of electrolytic fluid 112 with suspended pulverized glass input particulate material therein from outlet end 118 of cylinder 114 of ball mill 50.

Reservoir 132 is formed of any suitable size, shape and design and is configured to receive and hold a volume of electrolytic fluid 112 with suspended pulverized glass input particulate material therein in a relatively calm and stable manner so as to allow the suspended pulverized glass input particulate material to settle out of the electrolytic fluid 112. In this way, reservoir 132 of first sump conveyor 52 may be referred to as a “quiet pool”.

In the arrangement shown, as one example, an overflow port 140 is positioned in reservoir 132 that facilitates the drainage of electrolytic fluid 112 out of reservoir 132 of first sump conveyor 52. In the arrangement shown, as one example, as the fluid level 142 of electrolytic fluid 112 reaches the level of overflow port 140 electrolytic fluid 112 drains out of overflow port 140. In the arrangement shown, as one example, electrolytic fluid 112 exiting overflow port 140 passes through fluid conduit system 128, which in one arrangement may be a tube or pipe or other conduit, and into the reservoir 132 of second sump conveyor 54.

In the arrangement shown, as one example, overflow port 140 is positioned at the upper end of reservoir 132 at the forward end of reservoir 132. The placement of overflow port 140 in this position helps to allow electrolytic fluid 112 having a minimum of suspended pulverized glass input particulate material to exit the reservoir 132 of the first sump conveyor 52. In one arrangement, a filter member or other device is placed over overflow port 140 so as to minimize the suspended pulverized glass input particulate material that exits the reservoir 132 of the first sump conveyor 52 through overflow port 140.

In the arrangement shown, as one example, first sump conveyor 52 includes a belt 144. Belt 144 is formed of any suitable size, shape and design and is configured to extend along the bottom wall 146 of reservoir 132 in a slow, steady and non-disturbing manner so as to allow pulverized glass input particulate material suspended in electrolytic fluid 112 to settle out of the electrolytic fluid 112 and settle onto belt 144 as belt 144 slowly travels along the bottom wall 146 of reservoir 132. In the arrangement shown, as one example, belt 144 slowly travels upward at a slight angle as it moves forward through reservoir 132. This slight upward angle continues as belt 144 travels forward until belt 144 crosses the fluid level 142 at which point belt 144 and any accumulated pulverized glass input particulate material that settled on the belt 144 exits the electrolytic fluid 112 held within reservoir 132. As belt 144 continues this slight upward angle as it continues to move forward after exiting fluid level 142, any retained electrolytic fluid 112 contained in the accumulated pulverized glass input particulate material that settled on the belt 144 has a tendency to drain down the belt 144 and back into reservoir 132.

In the arrangement shown, as one example, belt 144 travels several feet after exiting fluid level 142 and before traveling around first pivot point 148 which provides a substantial amount of time for electrolytic fluid 112 within the pulverized glass input particulate material accumulated on belt 144 to drain back down into reservoir 132. In one arrangement, belt 144 angles upward at an angle of 10° and 13°, however any other angle or range of angles between 1° 30° is hereby contemplated for use. In one arrangement, belt 144 travels at around 2.375 ft./min, however any other speed or range of speeds are hereby contemplated including from 0.5 ft./min to 10 ft./min.

In the arrangement shown, as one example, belt 144 travels around a first pivot point 148 positioned at the forward-most and upward-most point of first sump conveyor 52. First pivot point 148 is formed of any suitable size, shape and design and in one arrangement is a roller, wheel or plurality of rollers or wheels or the like or any other object or device that belt 144 can move over or around. In the arrangement shown, as one example, belt 144 travels around first pivot point 148 before returning under bottom wall 146 of reservoir 132.

In the arrangement shown, as one example, belt 144 engages a tensioning pulley 150 just rearward of first pivot point 148. Tensioning pulley 150 is formed of any suitable size, shape and design and is configured to apply adjustable tension on belt 144 so as to ensure the proper tautness of belt 144 for optimal operation.

In the arrangement shown, as one example, belt 144 travels around a second pivot point 152 positioned below and at the rearward side of reservoir 132 of first sump conveyor 52.

Second pivot point 152 is formed of any suitable size, shape and design and in one arrangement is a roller, wheel or plurality of rollers or wheels or the like or any other object or device that belt 144 can move over or around. In the arrangement shown, as one example, belt 144 travels around second pivot point 152 before beginning to move upward on the rearward side of reservoir 132.

In the arrangement shown, as one example, belt 144 travels around a third pivot point 154 positioned above and at the rearward side of reservoir 132 of first sump conveyor 52. Third pivot point 154 is formed of any suitable size, shape and design and in one arrangement is a roller, wheel or plurality of rollers or wheels or the like or any other object or device that belt 144 can move over or around. In the arrangement shown, as one example, belt 144 travels around third pivot point 154 before beginning to move downward and into reservoir 132 at the rearward upper side of reservoir 132. In one arrangement, the third pivot point 154 serves as a tensioner as it may be adjusted to adjust the tension on belt 144. In one arrangement, a removal apparatus 155 is present that scrapes and/or removes residual material from belt 144. This removal apparatus 155 may be a stationary scraper, a stationary brush, a rotating scraper, a rotating brush, and/or any combination thereof and/or any other device that removes material from belt 144.

In the arrangement shown, as one example, belt 144 travels around a guide member 156 positioned at the lower rearward side within reservoir 132 of first sump conveyor 52. Guide member 156 is formed of any suitable size, shape and design and in one arrangement is a plurality of rolling discs, wheels and/or pulleys or the like or any other object or device that belt 144 can move over or around. In the arrangement shown, as one example, belt 144 travels around guide member 156 which causes belt 144 to descend to the lower rearward corner of reservoir 132 within electrolytic fluid 112 before beginning to move forward and upward along the upper side of bottom wall 146 again at which point pulverized glass input particulate material again begins to settle on the upper surface of belt 144. and into reservoir 132 at the rearward upper side of reservoir 132.

In one arrangement, as one example, guide member 156 is formed of a plurality of large circular discs that are connected at their center by an axle that runs through all of the discs. In one arrangement, a disc is positioned at each opposing outward side of belt 144 with at least one, if not a plurality of discs, positioned between the opposing outwardly positioned discs. In this way, the use of these large circular discs that are spaced along the width of belt 144 helps to cause belt 144 to make a slow, smooth and easy transition from a generally vertically downward trajectory after passing over third pivot point 154 to a forward and slightly upward trajectory after passing around guide member 156. Any other configuration is hereby contemplated for use as guide member 156.

In this way, the use of first pivot point 148, tensioning pulley 150, second pivot point 152, third pivot point 154 and guide member 156 facilitate continuous rotation of belt 144 through reservoir 132 of first sump conveyor 52 while providing the proper alignment, guidance and tensioning of belt 144.

In the arrangement shown, as one example, the accumulated pulverized glass input particulate material that settled on the belt 144 is dispensed off the forward end of first sump conveyor 52 as belt 144 moves around first pivot point 148. In one arrangement, the accumulated pulverized glass input particulate material falls off of belt 144 under the weight of gravity without more. In another arrangement, a scraper or other removal device 155 is used to ensure most if not all of the accumulated pulverized glass input particulate material on belt 144 is removed from belt 144 as belt 144 moves around first pivot point 148.

In one arrangement, accumulated pulverized glass input particulate material that is removed from belt 144 at the forward end of first sump conveyor 52 is deposited onto the belt 144 of second sump conveyor 54. It is to be noted that this deposit of accumulated pulverized glass input particulate material from the belt 144 of the first sump conveyor 52 onto the belt 144 of the second sump conveyor 54 occurs above the point at which the belt 144 of the second sump conveyor 54 exits the fluid level 142 of reservoir 132 of second sump conveyor 54 so as to ensure that the accumulated pulverized glass input particulate material deposited by the belt 144 of the first sump conveyor 52 does not disperse in the electrolytic fluid 112 contained within the reservoir 132 of second sump conveyor 54.

Second Sump Conveyor 54:

In the arrangement shown, as one example, system 10 includes a second sump conveyor 54. Second sump conveyor 54 is formed of any suitable size, shape and design and is configured to receive electrolytic fluid 112 and suspended pulverized glass input particulate material from first sump conveyor 52 and is configured to allow the remaining suspended pulverized glass input particulate material settle out of the electrolytic fluid 112 so as to allow the pulverized glass input particulate material to be effectively and efficiently separated from the electrolytic fluid 112.

In the arrangement shown, as one example, second sump conveyor 54 is similar to if not identical to first sump conveyor 52 and therefor the teachings presented herein with respect to first sump conveyor 52 apply equally to second sump conveyor 54 unless stated specifically herein otherwise. That is, second sump conveyor 54 includes the following components in a similar fashion and arrangement as they are presented in first sump conveyor 52, including: reservoir 132, overflow port 140, fluid level 142, belt 144, first pivot point 148, tensioning pulley 150, second pivot point 152, third pivot point, and guide member 156, among other features.

One difference between first sump conveyor 52 and second sump conveyor 54 is that the distance belt 144 of second sump conveyor 54 travels after exiting fluid level 142 is substantially longer than the distance belt 144 of first sump conveyor 52 travels after exiting fluid level 142. This additional length of travel of belt 144 of second sump conveyor 54 provides additional drainage time and additional drying time for the accumulated pulverized glass input particulate material on belt 144.

Another difference is that the reservoir 132 of second sump conveyor 54 receives electrolytic fluid 112 from overflow port 140 of reservoir 132 of first sump conveyor 52 through fluid conduit system 128, such as a tube or a pipe. In contrast, first sump conveyor 52 receives electrolytic fluid 112 from the outlet end 118 of cylinder 114 of ball mill 50.

Another difference is that the belt 144 of the second sump conveyor 54 receives pulverized glass input particulate material from the belt 144 of the first sump conveyor 52 after the belt 144 of the second sump conveyor 54 exits the fluid level 142 of its reservoir 132.

Another difference between first sump conveyor 52 and second sump conveyor 54 is that first sump conveyor 52 is aligned in an approximate perpendicular orientation to the second sump conveyor 54.

Another difference between first sump conveyor 52 and second sump conveyor 54 is that first sump conveyor 52 deposits its accumulated pulverized glass input particulate material onto the belt 144 of second sump conveyor 54. In contrast, second sump conveyor 54 deposits its accumulated pulverized glass input particulate material onto glass weigh conveyor 56.

While two sump conveyors are shown for use, any number of sump conveyors are hereby contemplated for use in the system 10 such as one, two, three, four, five, six, seven, eight, nine or ten or more. These multiple sump conveyors may run in parallel with one another, they may run in series together or they may run in a combination of series and parallel depending on the desired outcome of the system 10, the desired output and the desired recovery of glass input 80 among countless other variables.

In one arrangement, electrolytic fluid 112 passes through overflow port 140 in reservoir 132 of second sump conveyor 54, through fluid conduit system 128 and to a filtering system 158. Filtering system 158 is any form of a filtering device or system that is configured to remove residual suspended particles in electrolytic fluid 112 before electrolytic fluid 112 reaches the electrolysis machine 64. In one arrangement, filtering system 158 includes a filter member that allows the passage of fluid there through but captures solid suspended particles in the electrolytic fluid 112, such as pulverized glass input particulate matter, thereby removing this particulate matter from the electrolytic fluid 112 which may be reprocessed.

While arrangements are primarily described with reference to removal of suspended particulate material from electrolytic fluid 112 using sump conveyors, embodiments are not so limited. Rather, it is contemplated that some various arrangements may additionally or alternatively remove particulate material from electrolytic fluid 112 using, for example, mixer-settlers, centrifuges, filters, and/or any other device configured to separate solids from liquids.

Glass Weigh Conveyor 56:

In the arrangement shown, as one example, system 10 includes a glass weigh conveyor 56. Glass weigh conveyor 56 is formed of any suitable size, shape and design and is configured to receive glass input 80, which is treated pulverized glass input particulate material, from second sump conveyor 54 and conveys the treated pulverized glass input particulate material to glass discharge conveyor 60. In the arrangement shown, as one example, glass weigh conveyor 56 is formed of a conveying device 176 driven by a motor 174. In one arrangement, as one example, glass weigh conveyor 56 carries glass input 80, which is treated pulverized glass input particulate material, from second sump conveyor 54 and conveys the treated pulverized glass input particulate material to glass discharge conveyor 60.

In the arrangement shown, conveying device 176 is a belt 178 which travels around a first pivot point 180 and a second pivot point 182 in a circular manner as conveying device is driven by motor 174. Belt 178 is formed of any suitable size, shape and design and is configured to extend around pivot points 180 and 182 and facilitate transportation of the treated pulverized glass input particulate material to glass discharge conveyor 60. In the arrangement shown, as one example, belt 178 travels around a first pivot point 180 positioned at the forward-most and upward-most point of glass weigh conveyor 56. First pivot point 148 is formed of any suitable size, shape and design and in one arrangement is a roller, wheel or plurality of rollers or wheels or the like or any other object or device that belt 178 can move over or around. In the arrangement shown, as one example, belt 144 travels around first pivot point 148 and continued rearward on an upper side of conveying device 176. In the arrangement shown, as one example, belt 178 then travels around a second pivot point 182 positioned below and at the rearward side of conveying device 176. Second pivot point 182 is formed of any suitable size, shape and design and in one arrangement is a roller, wheel or plurality of rollers or wheels or the like or any other object or device that belt 178 can move over or around. In this example arrangement, second pivot point 182 is connected to and is rotated by motor 174, which moves belt 178. Additionally or alternatively, glass weigh conveyor 56 may be implemented using various other types of conveying devices 176 including but not limited to, for example, a drag chain, auger, hopper, gate, bucket elevator or the like or any other material handling device or system.

In one arrangement a glass weigh conveyor 56 includes a weigh system, like weigh system 110 described herein, that weighs the glass input 80 received by glass weigh conveyor 56. This weigh system of glass weigh conveyor 56 is formed of any suitable size, shape and design and is configured to weigh the amount of glass input 80 received by glass weigh conveyor 56. Based on the measured weight from the weigh system of glass weigh conveyor 56 the metered rate of reagent 102 of glass treatment feeder 58 is adjusted so that the amount of reagent 102 applied to the glass input 80, which is treated pulverized glass input particulate material, is adjusted so as to ensure an optimum amount of reagent 102 is applied to glass input 80, which is treated pulverized glass input particulate material, at all times. In this way, the inclusion of a weigh system of glass weigh conveyor 56 is helpful for optimizing the process and ensuring enough reagent 102 is used while also ensuring that too much reagent 102 is not used. In one arrangement, approximately 7% by weight of reagent 102 is added to the flow of glass input 80, which is treated pulverized glass input particulate material. However, any other range of weight is hereby contemplated for use, from 1% by weight up to 30% by weight, as well as any other range within that range.

In the arrangement shown, as one example, glass weigh conveyor 56 deposits glass input 80, which is treated pulverized glass input particulate material, into glass discharge conveyor 25.

Glass Discharge Conveyor 60:

In the arrangement shown, as one example, system 10 includes a glass discharge conveyor 60. Glass discharge conveyor 60 is formed of any suitable size, shape and design and is configured to convey glass input 80, which is treated pulverized glass input particulate material, from glass weigh conveyor to glass collection conveyor 62. In the arrangement shown, as one example, glass discharge conveyor 60 is formed of a conveying device, such as a belt, drag chain, auger, hopper, gate, bucket elevator or the like or any other material handling device or system. In one arrangement, as one example, glass discharge conveyor 60 is an auger system which facilitates mixing glass input 80, which is treated pulverized glass input particulate material, with reagent 102 deposited into the stream of glass input 80 by glass treatment feeder 58.

In the arrangement shown, as one example, glass discharge conveyor 60 carries glass input 80, which is treated pulverized glass input particulate material, from glass weigh conveyor 56 to glass collection conveyor 62.

Glass Treatment Feeder 58:

In the arrangement shown, as one example, system 10 includes a glass treatment feeder 58. Glass treatment feeder 58 is formed of any suitable size, shape and design and is configured to convey and dispense reagent 102 into the stream of glass input 80, which is treated pulverized glass input particulate material, that is discharged by ball mill 50 and treated by first sump conveyor 52 and second sump conveyor 54 so as to neutralize the leaching of residual lead or other heavy metals within the glass input 80.

In the arrangement shown, as one example, glass treatment feeder 58 is formed of a conveying device 194, such as a belt, drag chain, auger, hopper, gate, bucket elevator or the like or any other material handling device or system. In one arrangement, as one example, conveying device 194 of glass treatment feeder 58 is an auger or belt that receives reagent 102 on one end from a metering system 196 connected to a hopper 160 or other storage device that holds a bulk amount of reagent 102. Glass treatment feeder 58 then dispenses this reagent 102 into the stream of pulverized glass input particulate material through an input point 162 in the housing around glass discharge conveyor 60.

In this way, glass treatment feeder 58 injects or dispenses reagent 102 into the stream of pulverized glass input particulate material through input point 162 well before pulverized glass input particulate material are deposited into a bulk storage container 104 positioned at the end of glass discharge conveyor 60. Injecting reagent 102 into the stream of pulverized glass input particulate material at the input point 162 ensures that reagent 102 is well mixed with the pulverized glass input particulate material so as to ensure adequate coverage and effectiveness.

In one arrangement, the glass treatment feeder 58, hopper 160, input point 162 and glass weigh conveyor 56 (or weigh system) associated with glass discharge conveyor 60 are similar to, if not identical to, the trommel fines treatment conveyor 28, hopper 106, input point 108, and weigh system 110 associated with trommel fines discharge conveyor 26 in that these components serve similar purposes and may be formed of similar components and configurations. That is, these components are configured to facilitate the same or similar purposes. Glass treatment feeder 58 is configured to carry reagent 102 from hopper 160 to a stream of pulverized glass input particulate material carried by glass discharge conveyor 60, whereas trommel fines treatment conveyor 28 is configured to carry reagent 102 to a stream of fines 95. Hopper 160 is configured to hold a bulk amount of reagent 102 and dispense it to glass treatment feeder 58, whereas hopper 106 is configured to hold a bulk amount of reagent 102 and dispense it to trommel fines treatment conveyor 28. Input point 162 is configured to facilitate the injection of reagent 102 from glass treatment feeder 58 into the stream of pulverized glass input particulate material carried by glass discharge conveyor 60, whereas input point 108 is configured to facilitate the injection of reagent 102 from trommel fines treatment conveyor 28 into the stream of fines 95 carried by trommel fines discharge conveyor 26. Glass weigh conveyor 56 (or weigh system) is configured to weigh the amount of pulverized glass input particulate material that is carried by glass discharge conveyor 60 so that an optimum amount of reagent 102 may be metered into the pulverized glass input particulate material, whereas weigh system 110 is configured to weigh the amount or fines 95 that is carried by trommel fines discharge conveyor 26. As such, these components serve similar functions and therefor may be formed of similar components and/or systems.

Glass Collection Conveyor 62:

In the arrangement shown, as one example, system 10 includes a glass collection conveyor 62. Glass collection conveyor 62 is formed of any suitable size, shape and design and is configured to receive treated glass input 80, which is pulverized glass input particulate matter with reagent 102 mixed therein, from glass discharge conveyor 60 to a bulk storage container 104 for removal and use for other industrial uses.

In the arrangement shown, as one example, glass collection conveyor 62 is formed of a conveying device, such as a belt, drag chain, auger, hopper, gate, bucket elevator or the like or any other material handling device or system. In one arrangement, as one example, glass collection conveyor 62 carries glass input 80, which is pulverized glass input particulate matter with reagent 102 mixed therein from glass discharge conveyor 60 to be deposited into a bulk storage container 104. In the arrangement shown, as one example, glass collection conveyor 62 is reversible. That is, glass collection conveyor 62 may be operated in first direction, which fills a first bulk storage container 104 positioned at a first end of glass collection conveyor 62, and glass collection conveyor 62 may be operated in a second direction, which is opposite the first direction, which fills a second bulk storage container 104. This reversible nature of glass collection conveyor 62 allow more throughput and capacity by allowing a bulk storage container 104 positioned at one end of the glass collection conveyor 62 to be filled while the bulk storage container 104 at the opposite end of glass collection conveyor 62 is being removed and replaced.

Scales 163 or weigh systems may be associated with each bulk storage container 104 which communicate with a control system 164 having a microprocessor 166 and memory 168 and instructions 170 in the form of software, firmware, code or the like, that controls operation of components of the system 10 based on sensed information. Control system 164, based on the sensed information from the scales or weigh systems, determines which bulk storage container 104 to fill and therefor determines which direction of rotation to operate glass collection conveyor 62. When control system 164 senses one bulk storage container 104 is filled, control system 164 reverses the direction of rotation of glass collection conveyor 62 thereby filling the other bulk storage container 104 so that the filled bulk storage container 104 may be removed and replaced with an empty bulk storage container 104.

Control System 164, Microprocessor 166, Memory 168, Instructions 170:

In the arrangement shown, as one example, system 10 includes a control system 164. Control system 164 is formed of any suitable size, shape and design and is configured to control operation of some or all of the electronic components of the system 10. In the arrangement shown, as one example, control system 164 includes one or more microprocessors 166, memory 168, or one or more memory devices, and instructions 170, among multiple other components and systems

In the arrangement shown, as one example, control system 164 is electrically connected, either through wired connections or wirelessly, to sensors and other electronic components positioned throughout the system 10 that provide information to control system 164. In the arrangement shown, as one example, control system 164 is electrically connected to motors, solenoids, valves, actuators and other controllable components of the system 10 which facilitates the ability to control operation of the system by control system 164. In the arrangement shown, control system 164 receives information from the sensors and other electronic components throughout the system 10, microprocessor 166 processes this information according to instructions 170 stored in memory 168 and then outputs commands thereby controlling operation of the system 10.

Microprocessor 166 is any computing device that receives and processes information and outputs commands according to instructions stored in memory 168. Memory 168 is any form of information storage such as flash memory, ram memory, a hard drive, or any other form of memory. Memory 168 may be included as a part of or operably connected to microprocessor 166. Control system 164 may be a single component that is located at a single physical location. Alternatively, control system 164 may be formed of multiple electronic components that are separated but electrically connected to one another that act in concert with one another.

Microprocessor 166 may be a single component that is located at a single physical location. Alternatively, microprocessor 166 may be formed of multiple electronic components that are separated but electrically connected to one another that act in concert with one another.

Memory 168 may be a single component that is located at a single physical location. Alternatively, memory 168 may be formed of multiple electronic components that are separated but electrically connected to one another that act in concert with one another.

Microprocessor 166 and memory 168 may be a single joined component that is located at a single physical location. Alternatively, microprocessor 166 and memory 168 may be formed of multiple electronic components that are separated but electrically connected to one another that act in concert with one another.

In one arrangement, control system 164, which its microprocessor 166, memory 168 and instructions 170 controls operation of system 10 in a continuous manner. That is, control system 164 senses operational characteristics of the components of the system 10 and adjusts various operational characteristics both in a reactionary manner as well as in a proactive manner so as to optimize operation of the system 10.

In some arrangements, artificial intelligence and machine learning is applied to system 10 through control system 164 to help manage and operate system 10. For example, in one or more arrangements, control system 164 may be configured and arranged to monitor, learn, and modify one or more features, functions, and/or operations of the system. For instance, control system 164 may be configured to monitor and/or analyze sensor data stored in memory 168 or database connected to system 10 and learn, over time, operation parameters of system 10 (flow rates of glass input 80, concentration and/or Ph of electrolytic fluid 112, temperature, weight measurements, etc) which provide the greatest lead reductions, throughput, or other desired variable to be optimized. Such learning may include, for example, generation and refinement of classifiers and/or state machines configured to map data values to outcomes of interest or to operations to be performed by the system 10. In various embodiments, analysis by the control system 164 may include various guided and/or unguided artificial intelligence and/or machine learning techniques including, but not limited to: neural networks, genetic algorithms, support vector machines, k-means, kernel regression, discriminant analysis and/or various combinations thereof. In different implementations, analysis may be performed locally, remotely, or a combination thereof.

Filtering System 158:

In the arrangement shown, as one example, system 10 includes a filtering system 158. Filtering system 158 is formed of any suitable size, shape and design and is configured to remove residual suspended particles in electrolytic fluid 112 before electrolytic fluid 112 reaches the electrolysis machine 64 for reprocessing. In one arrangement, filtering system 158 includes a filter member that allows the passage of fluid there through but captures solid suspended particles in the electrolytic fluid 112, such as pulverized glass input particulate matter, thereby removing this particulate matter from the electrolytic fluid 112 may be reprocessed.

In the arrangement shown, as one example, filtering system 158 is positioned in the fluid flow path of fluid conduit system 128 between the overflow port 140 of reservoir 132 of second sump conveyor 54 and the electrolysis machine 64.

Electrolysis Machine 64 & Electrolysis Rectifier 66:

In the arrangement shown, as one example, system 10 includes an electrolysis machine 64 and electrolysis rectifier 66. Electrolysis machine 64 is formed of any suitable size, shape and design and is configured to remove lead and other heavy metals dissolved in electrolytic fluid 112. Electrolysis rectifier 66 is formed of any suitable size, shape and design and is configured to deliver low voltage DC electric current in the range of 0-5 volts (or any other range) to the electrolysis machine 64 for removal of lead and other heavy metals from the electrolytic fluid 112.

In the arrangement shown, as one example, electrolysis machine 64 includes a tank 186 having a first set of rotating plates 188 that are partially submerged below the fluid line 190 of the tank while they rotate. In one arrangement, this first set of rotating plates are formed of stainless steel, however any other configuration is hereby contemplated for use. This first set of rotating plates is charged with a negative charge from electrolysis rectifier 66, while a second set of plates, which are positioned partially or wholly within the electrolytic fluid 112 and between the individual plates of the first set of plates, are charged with a positive charge from electrolysis rectifier 66. This arrangement causes lead and other heavy metals in the electrolytic fluid 112 to plate to the plurality of negatively charged plates. This removes the lead and other heavy metals from the electrolytic fluid.

In one arrangement, as one example, these negatively charged plates, which is the first set of rotating plates, rotate on a horizontal shaft that extends through the first set of rotating plates, however multiple sets of rotating plates are hereby contemplated for use, as is any other arrangement. This rotation causes portions of the first set of rotating plates to be submerged within the electrolytic fluid 112 while other portions of the first set of rotating plates are outside of the electrolytic fluid 112. A scraper is engaged with the first set of rotating plates. As the plates rotate around and engage the scraper, the scraper removes the plated lead and other heavy metals that have accumulated on the plate due to the plating.

As the lead and other heavy metals are scraped off of the first set of rotating plates, this lead and other heavy metals is transferred to briquette machine feed conveyor 68. In one arrangement, this lead and other heavy metals has the consistency of a paste at the time it is scraped off of the first set of rotating plates.

Any other form of an electrolysis machine 64 or system for removing lead or other heavy metals from electrolytic fluid 112 is hereby contemplated for use. As is any other manner of removing lead or other heavy metals from electrolytic fluid 112.

In the arrangement shown, as one example, two electrolysis machines 64 are shown in use in series. However any other number of electrolysis machines 64 is hereby contemplated for use, such as one, two, three, four, five, six, seven, eight, nine, ten or more, and these electrolysis machines 64 may be in series, in parallel or in a combination of series and parallel with one another. In the arrangement shown, as one example, electrolytic fluid 112 is processed by the first electrolysis machine 64 and then this purified electrolytic fluid 112 flows to the second electrolysis machine 64 for further purification.

Once the electrolytic fluid 112 is purified, meaning that lead and other heavy metals are removed from the electrolytic fluid 112 to a desired level, the purified electrolytic fluid 112 flows through fluid conduit system 128 downstream to pump system 126, water heater 130 and fluid processing system 172, as is further described herein.

Briquette Machine Feed Conveyor 68:

In the arrangement shown, as one example, system 10 includes a briquette machine feed conveyor 68. Briquette machine feed conveyor 68 is formed of any suitable size, shape and design and is configured to receive lead and other heavy metals that are scraped off of the first set of rotating plates of electrolysis machine 64. In the arrangement shown, as one example, briquette machine feed conveyor 68 is formed of a conveying device, such as a belt, drag chain, auger, hopper, gate, bucket elevator or the like or any other material handling device or system.

In the arrangement shown, as one example, briquette machine feed conveyor 68 collects and conveys the collected lead and other heavy metals to briquette machine 70. In one arrangement, briquette machine feed conveyor 68 as well as briquette machine 70 has a fluid conduit system 128 that returns electrolytic fluid 112 that drains from the output of electrolysis machine 64 back to electrolysis machine 64 for reprocessing. In this way, briquette machine feed conveyor 68 allows electrolytic fluid 112 held within the output of electrolysis machine 64 to drain from the lead or other heavy metals removed by electrolysis machine 64. This allows the natural removal of electrolytic fluid 112, which is then returned to electrolysis machine 64 for reprocessing.

In the arrangement shown, as one example, the drained output of electrolysis machine 64 that is received by briquette machine feed conveyor 68 is transferred to briquette machine 70 for further processing.

Briquette Machine 70:

In the arrangement shown, as one example, system 10 includes a briquette machine 70. Briquette machine 70 is formed of any suitable size, shape and design and is configured to receive the drained output of electrolysis machine 64 that is transferred by briquette machine feed conveyor 68 to briquette machine 70. In the arrangement shown, as one example, briquette machine 70 is configured to receive the lead and other heavy metal output from electrolysis machine 64, which in one arrangement is in a past-like form, and briquette machine 70 is configured to further drain, dry and compact this output from electrolysis machine 64. The output fluid from briquette machine 70 is returned and/or recirculated to the system 10 for reuse. In one arrangement, briquette machine 70 is formed of a receiving hopper. In another arrangement, briquette machine 70 is formed of a press like device that presses the output from electrolysis machine 64 into briquettes. Any other form of a processing device is hereby contemplated for use as briquette machine 70.

In the arrangement shown, as one example, the output of briquette machine 70 is transferred to a bulk storage container 104 and is used for other industrial uses.

Pump System 126 & Water Heater 130 & Fluid Processing System 172:

In the arrangement shown, as one example, electrolytic fluid 112 that exits electrolysis machine 64 is recirculated and processed for use in the system 10 in a continuous loop through fluid conduit system 128.

In the arrangement shown, as one example, system 10 includes a pump system 126. Pump system 126 is formed of any suitable size, shape and design and is configured to facilitate movement of electrolytic fluid 112 through the system 10. Pump system 126 may include one or more fluid pumps.

In the arrangement shown, as one example, system 10 includes a water heater 130. Water heater 130 is formed of any suitable size, shape and design and is configured to facilitate heating of electrolytic fluid 112 to optimal operational temperatures for use in the system 10. Water heater 130 may include one or more water heaters or fluid heating systems. In one arrangement, water heater 130 is a tankless continuous flow fluid heating device.

In the arrangement shown, as one example, system 10 includes a fluid processing system 172. Fluid processing system 172 is formed of any suitable size, shape and design and is configured to further process electrolytic fluid 112 to optimal operational characteristics for use in the system 10. That is, in one arrangement, fluid processing system 172 monitors the condition of electrolytic fluid 112 so that the electrolytic fluid 112 may be manually modified by the addition and/or subtraction of components to the electrolytic fluid 112. That is, in one arrangement, fluid processing system 172 monitors the condition of electrolytic fluid 112 and automatically modifies electrolytic fluid 112 by the addition and/or subtraction of components to the electrolytic fluid 112.

In one arrangement, fluid processing system 172 monitors the PH of electrolytic fluid and controls the PH range of electrolytic fluid 112 by the addition of acid or base to electrolytic fluid 112. For example, in an example arrangement wherein electrolytic fluid 112 is a base having potassium hydroxide therein, fluid processing system 172 is configured to add granular potassium hydroxide to electrolytic fluid 112 so as to maintain the PH level of electrolytic fluid within a defined PH range.

In the arrangement shown, as one example, once electrolytic fluid 112 is processed by fluid processing system 172 the purified and controlled electrolytic fluid 112 is then transferred through fluid conduit system 128 for use in ball mill 50 again. This process continues in a continuous cycle.

In Operation:

In the arrangement shown, as one example of use of the system 10 to process televisions or monitors 72, the system 10 operates in the following manner: A plurality of televisions or monitors 72 are dismantled by separating cathode ray tubes 74, electronic components 76 and housings 78. In one arrangement, the screen-portion 75 is separated from the cathode ray tubes 74, which are then used as glass input 80.

In the arrangement shown, as one example, cathode ray tube 74, which form glass input 80, are transferred to box tipper 14. Next, glass input 80 is transferred by box tipper 14 to surge hopper with feeder 16. Next, surge hopper with feeder 16 meters out glass input 80 at a desired rate for optimal performance of system 10.

Next, the metered glass input 80 from surge hopper with feeder 16 is received by first inclined conveyor 18. First incline conveyor 18 carries glass input 80 to trommel feed conveyor 20. Next, glass input 80 received by trommel feed conveyor 20 is loaded into trommel 22 through inlet end 90 such that glass input 80 is initially held within first section 98.

As trommel 22 operates, glass input 80 is processed. That is, as the cylinder 88 rotates, glass input 80 is in constant motion. As cylinder 88 rotates, the particles of glass input 80 engage one another, and in the process the particles of glass input 80 are further broken down into smaller particulate size while also removing coating 86 from the surface of the particles of glass input 80.

Glass input 80 flows from first section 98 of cylinder 88 into the second section 100 of cylinder 88. As cylinder 88 rotates, fines 95 contained within glass input 80 pass through the perforations in perforated material 94 of second section 100. These fines 95 are captured in the space between cylinder 88 and exterior housing 96 and are conveyed by trommel fines conveyor 24 to trommel fines discharge conveyor 26.

Fines 95 are weighed by weigh system 110 and an optimum amount of reagent 102 from hopper 106 is applied to the stream of fines 95 through input point 108 by trommel fines treatment conveyor 28. Fines 95 and reagent 102 are adequately mixed as they are conveyed by trommel fines discharge conveyor 26. Fines 95 and reagent 102 are then deposited into bulk storage container 104 for resale and/or disposal and/or for other industrial uses.

The particles of glass input 80 that pass through trommel 22 exit trommel 22 through outlet end 92 and are received by drag chain conveyor 30. Glass input 80 is conveyed by drag chain conveyor 30 to pulverizer 32. As glass input 80 passes through pulverizer 32 the mechanical action of pulverizer 32 reduces the particle size of glass input 80. Glass input 80 exits pulverizer 32 and is received by pulverizer screw conveyor 34 and then is passed through under magnet belt conveyor 36 and overhead belt magnet separator 38 which removes any residual metallic components from the stream of glass input 80.

In one arrangement, glass input 80 exits under magnet belt conveyor 36 and overhead belt magnet separator 38 and is received by smelter flux lead removal reversing conveyor 40 which is configured to selectively deposit glass input into bulk storage container 104 for use as smelter flux or other industrial purposes.

Alternatively, glass input 80 continues onto spanner conveyor 42 and then is transferred to second incline conveyor feed conveyor 44 and then onto second incline conveyor 46. Second incline conveyor 46 carries glass input 80 to ball mill feed conveyor 48.

Ball mill feed conveyor 48 deposits glass input 80 into inlet end 116 of cylinder 114 of ball mill 50 as a desired rate. Simultaneously, electrolytic fluid 112 is deposited into the stream of glass input 80 by an outlet port of fluid conduit system 128.

As cylinder 114 of ball mill 50 rotates, glass input 80 is tumbled within the hollow interior 120 of cylinder 114 along with balls 122. The mechanical interaction between glass input 80, the plurality of balls 122 and the sides, or tiles 124, of cylinder 114 pulverize glass input 80 into increasingly smaller particles.

This mechanical action occurs while glass input 80 is exposed to electrolytic fluid 112. As the glass input 80 is broken down in size this exposes lead component and/or heavy metal component 84, contained within glass input, to a surface of the particles. Once lead component and/or heavy metal component 84 exposed to a surface of a particle, the lead component and/or heavy metal component 84 is accessible to electrolytic fluid 112. Once the electrolytic fluid 112 makes contact with the lead component and/or heavy metal component 84, the electrolytic fluid 112 pulls lead component and/or heavy metal component 84 into the electrolytic fluid 112 while leaving the glass component 82 behind. That is, the lead component and/or heavy metal component 84 is dissolved into electrolytic fluid 112 while the glass input 80 is left as a solid.

After dwelling within hollow interior 120 of cylinder 114 of ball mill 50 for an optimum amount of time, and being processed to a desired particle size, glass input 80, which is now in the form of pulverized glass input particulate matter, passes through openings in grate 135 and out the outlet end 118 of cylinder 114 of ball mill 50.

As glass input 80, which is now in the form of pulverized glass input particulate matter, exits outlet end 118 of cylinder 114 of ball mill 50, glass input 80, which is now in the form of pulverized glass input particulate matter is received within reservoir 132 of first sump conveyor 52. While being held within reservoir 132, glass input 80, which is now in the form of pulverized glass input particulate matter, settles out from electrolytic fluid 112. As glass input 80, which is now in the form of pulverized glass input particulate matter settles out from electrolytic fluid 112, glass input 80 accumulates on the upper surface of belt 144 as it travels along the bottom wall 146 of reservoir 132. Belt 144 travels slightly upward as it travels forward until belt 144 passes fluid level 142 at which point the settled glass input 80, which is now in the form of pulverized glass input particulate matter is separated from electrolytic fluid 112.

Belt 144 carries glass input 80, which is now in the form of pulverized glass input particulate matter upward as residual electrolytic fluid 112 held within the glass input 80, which is now in the form of pulverized glass input particulate matter drains down belt 144 and back into reservoir 132. Belt 144 deposits the accumulated glass input 80, which is now in the form of pulverized glass input particulate matter onto belt 144 of second sump conveyor 54 above the fluid level 142 of second sump conveyor 54.

Electrolytic fluid 112, with suspended glass input 80 therein, within reservoir 132 of first sump conveyor 52 exits through overflow port 140. Electrolytic fluid 112 passes through fluid conduit system 128 and into the reservoir 132 of second sump conveyor 54.

While being held within reservoir 132 of second sump conveyor 54, residual glass input 80, which is now in the form of pulverized glass input particulate matter, that was not removed by first sump conveyor 52 settles out from electrolytic fluid 112. As glass input 80, which is now in the form of pulverized glass input particulate matter settles out from electrolytic fluid 112, glass input 80 accumulates on the upper surface of belt 144 as it travels along the bottom wall 146 of reservoir 132 of second sump conveyor 54. Belt 144 travels slightly upward as it travels forward until belt 144 passes fluid level 142 at which point the settled glass input 80, which is now in the form of pulverized glass input particulate matter is separated from electrolytic fluid 112. Notably, belt 144 of second sump conveyor 54 travels upward at a lower rate as compared to first sump conveyor 52 so as to allow residual glass input 80, which is now in the form of pulverized glass input particulate matter adequate time to settle out of electrolytic fluid 112.

Belt 144 carries glass input 80, which is now in the form of pulverized glass input particulate matter upward as residual electrolytic fluid 112 held within the glass input 80, which is now in the form of pulverized glass input particulate matter drains down belt 144 and back into reservoir 132. This process is continued for as many sump conveyors 52/54 as is needed to remove an adequate amount of glass input 80 from electrolytic fluid 112.

In the arrangement shown, belt 144 of second sump conveyor 54 deposits the accumulated glass input 80, which is now in the form of pulverized glass input particulate matter onto glass weigh conveyor 56. Glass weigh conveyor 56 weighs glass input 80, which is now in the form of pulverized glass input particulate matter, and passes the glass input 80, which is in the form of pulverized glass input particulate matter, onto glass discharge conveyor 60.

Based on the weight measurement from glass weigh conveyor 56, an optimum amount of reagent 102 from hopper 160 is applied to the stream of glass input 80, which is in the form of pulverized glass input particulate matter through input point 162 by glass treatment feeder 58. Glass input 80, which is in the form of pulverized glass input particulate matter and reagent 102 are adequately mixed as they are conveyed by glass discharge conveyor 60. Glass input 80, which is in the form of pulverized glass input particulate matter and reagent 102 are then deposited onto glass collection conveyor 62 and are into bulk storage container 104 for disposal and/or for other industrial uses.

After most, if not all, of glass input 80, which is in the form of pulverized glass input particulate matter, settles out of electrolytic fluid 112 in reservoir 132 of second sump conveyor 54, electrolytic fluid 112 exits overflow port 140 of second sump conveyor 54. Electrolytic fluid 112 passes through fluid conduit system 128 to filter system 158. Filter system 158 serves to remove most, if not all, residual glass input 80 and/or other particulate material from electrolytic fluid 112.

Electrolytic fluid 112 then passes through fluid conduit system 128 to electrolysis machine 64. Electrolysis machine 64 removes dissolved lead component and/or heavy metal component 84 from electrolytic fluid 112 by an electrolysis process. In one arrangement, lead component and/or heavy metal component 84 is plated onto plates of electrolysis machine 64 which is removed by a scraper and deposited onto briquette machine feed conveyor 68. This removed lead component and/or heavy metal component 84 is conveyed by briquette machine feed conveyor 68 to briquette machine 70 which removes residual electrolytic fluid 112 and deposits the remaining lead component and/or heavy metal component 84 into a bulk storage container 104 for resale and/or disposal and/or other industrial purposes.

The electrolytic fluid 112 exits electrolysis machine 64 after having lead component and/or heavy metal component 84 removed from the electrolytic fluid 112 through fluid conduit system 128. Electrolytic fluid 112 passes through pump system 126 water heater 130 which heats electrolytic fluid 112, and fluid processing system 172 which monitors and amends and controls the characteristics of electrolytic fluid 112 within an optimal range. Electrolytic fluid 112 is then recirculated through the system 10 in a continuous cycle. Notably, it is contemplated that pump system 126, water heater 130 and/or fluid processing system 172 may be located at various locations in the flow of electrolytic fluid 112, and/or there may be multiple pump systems 126, water heaters 130 and/or fluid processing systems 172 at various locations in the flow of electrolytic fluid 112.

Non-Glass Example: In the arrangement shown, as one example, glass input 80 having a lead component and/or heavy metal component 84 is shown in use with the system 10. However, use of system 10 with glass input 80 having a lead component and/or heavy metal component 84 is only one of countless examples of use. It is hereby contemplated that system 10 may be used with any bulk input material. As one example, any material having a target component for reclamation (e.g., lead , other heavy metal, non-heavy metal, and/or rare earths) is hereby contemplated for use. In particular it is hereby contemplated any electronic component, such as circuit boards, microprocessors, electronics, switches, controllers, LEDs, flat screen monitors and televisions, computers, or any other electronic device may be used in the system 10 with appropriate changes to the pre-processing steps. That is, with appropriate preparation of the input material, ball mill 50 and all of the downstream processes may be used to remove lead component and/or heavy metal component 84 from this non-glass input material.

Example Process:

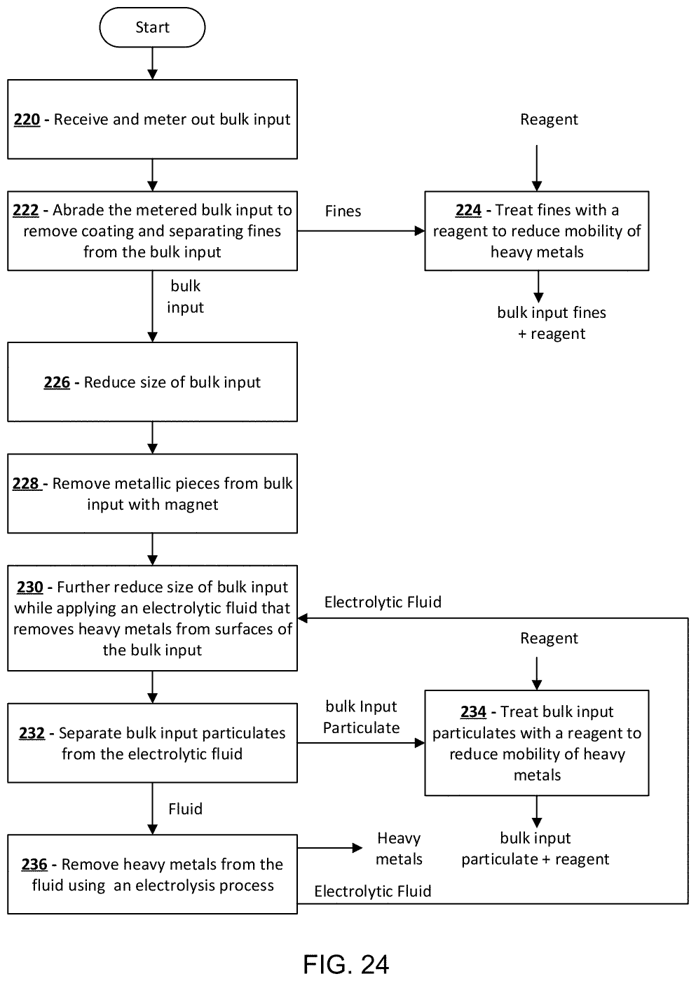

FIG. 24 shows a general process for reclamation of heavy metals such as lead from a bulk input 80 material. At block 220, bulk input 80 material is received and metered out. The bulk input 80 material is received and metered out using for example, box tipper 14 and surge hopper with feeder 16 as previously described. However, it is contemplated that various arrangements may additionally or alternatively use any other mechanism, device, or means for receiving and metering of a bulk material.

At block 222, the metered bulk material is abraded to remove any coating on the bulk material. Fines 95 generated by the abrading are also separated at block 222. In some various arrangements, the coating may be removed using, for example, trommel 22 as previously described. However, it is contemplated that various arrangements may additionally or alternatively use any other mechanism, device, or means to physically remove a coating from the bulk material. It is also recognized that some types or sources of bulk input 80 material may not have a coating requiring removal. Accordingly, it is contemplated that is one or more arrangement, processing at block 222 may be omitted.

At block 224, the separated fines 95 are treated with a reagent 102 to reduce mobility of heavy metals in the fines 95. In some various arrangements, the fines may be transported and treated with reagent 102 using, for example, trommel fines conveyor 24, trommel fines discharged conveyor 26, and trommel fines treatment conveyor 28 as previously described. However, it is contemplated that various arrangements may additionally or alternatively use any other mechanism, device, or means to transport and treat fines 95 with reagent 102.

At block 226, bulk input 80 is processed to reduce the size of pieces forming the bulk input 80. However, it is recognized that in some arrangements and/or some sources of bulk material, it may not be necessary to reduce the size of pieces forming the bulk input 80 at block 226. Accordingly, in some arrangements, processing at block 226 may be omitted.

As previously described, some bulk input 80 materials may include stray metallic pieces as a result of harvesting the bulk input 80 material from recycled consumer products. At block 228, metallic pieces are removed from the bulk input 80 with a magnet. Additionally or alternatively, metal may be removed with any other mechanism, device, or means to separate stray metal pieces from the bulk input 80 materials

At block 230, the bulk input 80 is reduced or further reduced in size while applying an electrolytic fluid 112 that removes heavy metals from surfaces of the bulk input 80. In the case of leaded glass input material, as one example, the glass input may be pulverized into a powder. The bulk input 80 material may be reduced in size while applying electrolytic fluid 112 using, for example, ball mill 50, pump system 126, and fluid conduit system 128 as previously described. However, it is contemplated that various arrangements may additionally or alternatively use any other mechanism, device, or means for reducing bulk input 80 material in size and applying electrolytic fluid 112 thereto.

At block 232, bulk input 80 particulates resulting from the processing at block 230 are separated from the electrolytic fluid 112. In some arrangements, bulk input 80 particulates may be separated from the electrolytic fluid 112 using, for example, one or more sump conveyors 52 and/or 54 as previously described. Additionally or alternatively, the process may remove particulate input 80 material from electrolytic fluid 112 using any other mechanism, device, or means for separating solids from fluids including but not limited to, for example, mixer-settlers, centrifuges, and/or filters.

At block 234, the separated bulk input 80 particulates are treated with a reagent 102 to reduce mobility of heavy metals in the bulk input 80 particulates. In some arrangements, bulk input 80 particulates may be treated with a reagent 102 using, for example, glass treatment feeder 58 as previously described. However, it is contemplated that various arrangements may additionally or alternatively use any other mechanism, device, or means to treat bulk input 80 particulates with reagent 102.

At block 236, heavy metals are removed from electrolytic fluid 112 using an electrolysis process. In some arrangements, heavy metals are removed from the electrolytic fluid 112 using, for example, electrolysis machine 64 and electrolysis rectifier 66 as previously described. However, it is contemplated that various arrangements may additionally or alternatively use any other mechanism, device, or means for removal of heavy metals from electrolytic fluids. The removed heavy metals may be processed, formed, or packaged for reuse in various other applications. The resulting electrolytic fluid 112 is reused in processing of bulk material at block 230.

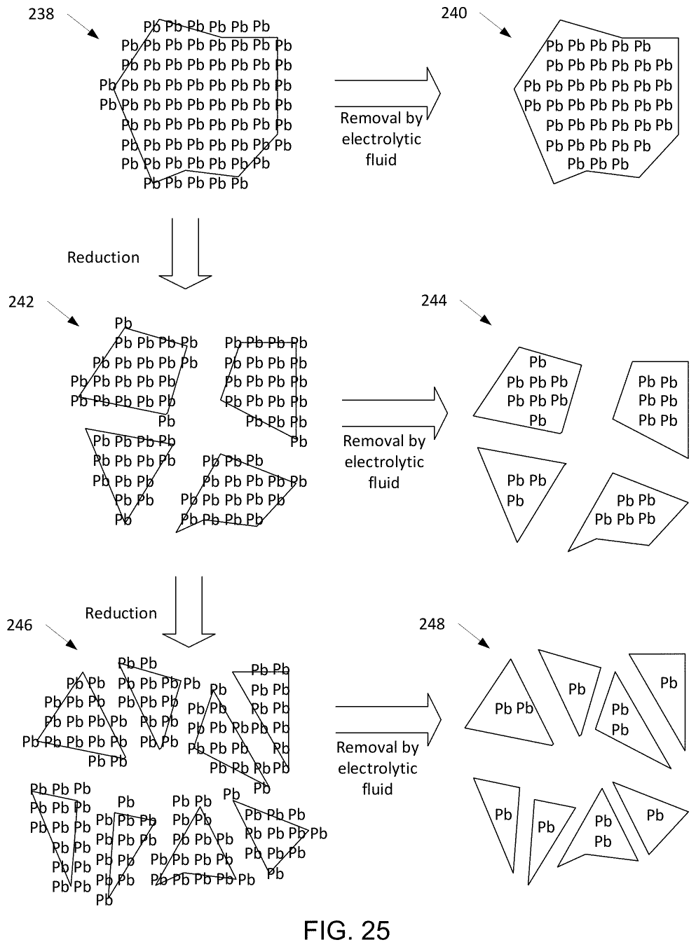

FIG. 25 depicts three example processes flows for removing lead from an example glass input 80 by an electrolytic fluid 112. And/or FIG. 25 shows glass input 80 being broken up into three distinct sizes during processing in ball mill 50. The more dwell time in the ball mill 50 the smaller the particle size glass input 80 is broken down to and the more lead and heavy metals are removed from the glass input 80.

In a first process, a piece of glass input 238 is processed by electrolytic fluid 112 to remove lead from exposed portions of the piece glass input 238 to produce a processed piece of glass input 240. As shown in FIG. 25, a center of the processed piece of glass input 240 has a high concentration of lead remaining. If the processed piece of glass input 240 tested with a TCLP test, the remaining lead will be exposed (by breaking up the glass which is often done when performing a TCLP test) and may prevent the processed piece of glass input 240 from passing.

In a second process, the piece of glass input 238 is processed to reduce the piece of glass input 238 into smaller pieces of glass input 242. This processing increases surface area of the glass input and exposes more lead. The smaller pieces of glass input 242 are processed by electrolytic fluid 112 to remove lead from exposed portions of the smaller pieces of glass input 242 to produce processed smaller pieces 244. As shown in FIG. 25, a greater amount of lead is able to be removed in the processed pieces 244 in comparison to the larger processed piece of glass input 240. This is due to the smaller particle size having more surface area per volume of the particle which exposes more lead and heavy metals on the surface of the particles of glass input 80.

In a third process, the smaller pieces of glass input 242 are further reduced to produce even smaller pieces 246. The smaller pieces of glass input 246 are processed by electrolytic fluid 112 to remove lead from exposed portions of the smaller pieces of glass input 246 to produce processed smaller pieces 248. As shown in FIG. 25, a greater amount of lead is able to be removed in the processed pieces 248 in comparison to the larger processed pieces of glass input 244.

The example process shown in FIG. 25 illustrate the observation that a greater amount of lead can generally be extracted from glass input 80 as size of the glass input 80 is reduced. Although the processes in FIG. 25 reduce glass input 80 before applying electrolytic fluid, embodiments are not so limited. Rather, in one or more arrangements, ball mill 50 is configured to continuously reduce the size of glass input 80 while electrolytic fluid 112 is applied to the glass input 80.

Although it has been observed that a greater amount of lead can be extracted from glass input 80 as size of the glass input 80 is reduced, it has also been observed that glass input 80 may be reduced into a size that is too small to permit the glass input 80 particles to be effectively and efficiently separated from the electrolytic fluid 112. In one or more arrangements, ball mill 50 is configured to reduce glass input 80 down to an effective size to permit electrolytic fluid 112 to remove enough lead to pass a TCLP test, while also permitting the glass input 80 to be separated from the electrolytic fluid 112 via a settling process (e.g., using a sump conveyor 52/54). Testing has shown that reducing glass input 80 down to flour like consistency (e.g., a size of approximately 50 microns or less, so as to permit glass input to pass through a 300 mesh filter) is sufficient to permit a TCLP test while permitting the processed glass input 80 to be separated from the electrolytic fluid 112.

However, it is contemplated that larger or smaller size of glass input 80 may be used to facilitate adequate removal of lead from glass input 80 while permitting effective and efficient separation from electrolytic fluid 112. For example, in one or more arrangements, glass input 80 may be reduced to a size in the range of 1000-1 microns while being processed (e.g., in ball mill 50). As another example, in one or more arrangements, glass input 80 may be reduced to a size in the range of 500-1 microns while being processed. As yet another example, in one or more arrangements, glass input 80 may be reduced to a size in the range of 250-1 microns while being processed. As another example, in one or more arrangements, glass input 80 may be reduced to a size in the range of 100-1 microns while being processed. As yet another example, in one or more arrangements, glass input 80 may be reduced to a size in the range of 50-1 microns while being processed (e.g., in ball mill 50). As another example, in one or more arrangements, glass input 80 may be reduced to a size in the range of 40-1 microns while being processed (e.g., in ball mill 50). As yet another example, in one or more arrangements, glass input 80 may be reduced to a size in the range of 30-1 microns while being processed (e.g., in ball mill 50). As another example, in one or more arrangements, glass input 80 may be reduced to a size in the range of 20-1 microns while being processed (e.g., in ball mill 50). As yet another example, in one or more arrangements, glass input 80 may be reduced to a size in the range of 10-1 microns while being processed (e.g., in ball mill 50). As yet another example, in one or more arrangements, glass input 80 may be reduced to a size that is less than 1 microns while being processed (e.g., in ball mill 50).

Furthermore, it is contemplated that one or more arrangements may utilize a centrifuge for separating glass input 80 particles from electrolytic fluid 112, which may permit nearly any size glass input 80 to be effectively and efficiently separated from electrolytic fluid 112.

In the arrangement shown, as one example, the size that glass input is reduced to by ball mill 50 depends a number of factors including, throughput speed of glass input 80, speed at which ball mill 50 is rotated, and/or configuration of balls in ball mill 50 (e.g., sizes of balls, shapes of balls, material forming balls, and/or weight of balls). In one or more arrangements, these factors may be adjusted to achieve the desired amount of lead reduction with minimal energy and/or material costs. Additionally or alternatively, the amount of lead that is removed from glass input 80 may increase/decreased by adjustment of various other factors including, but not limited to, for example, temperature of solution, room temperature, concentration of solution, ratio of solution to glass input in ball mill 50, length of time glass input 80 is in contact with electrolytic fluid 112.

### Alternative Arrangement(s):

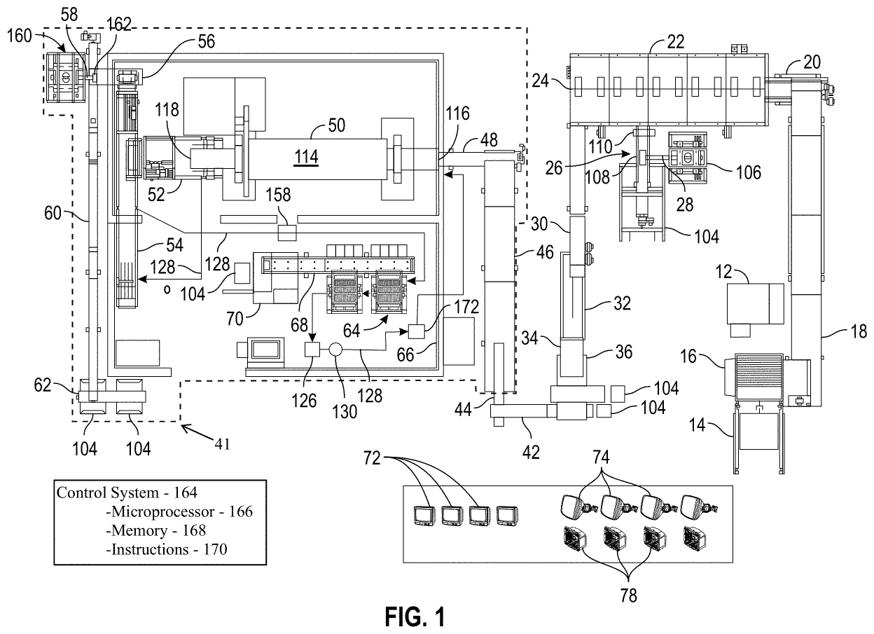

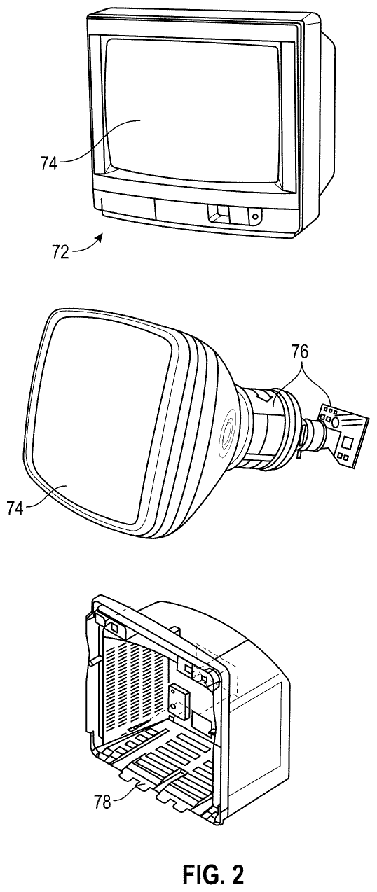

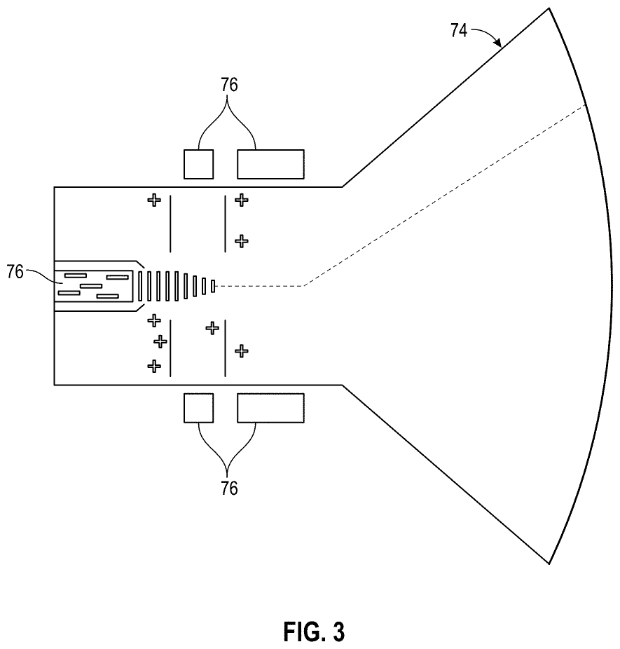

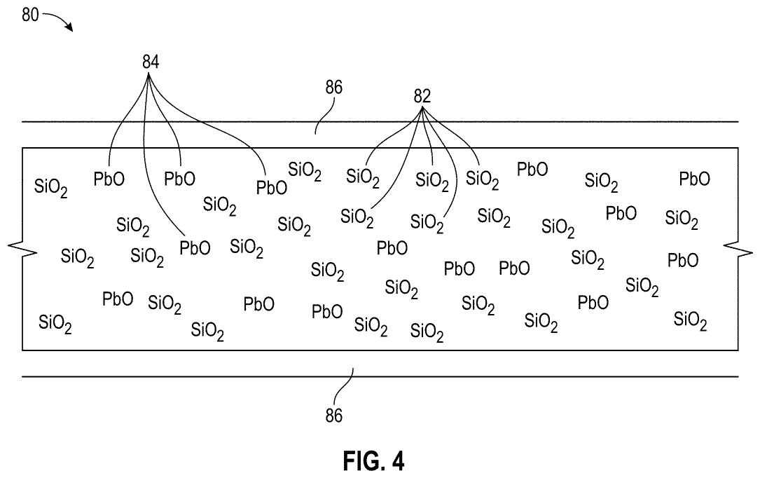

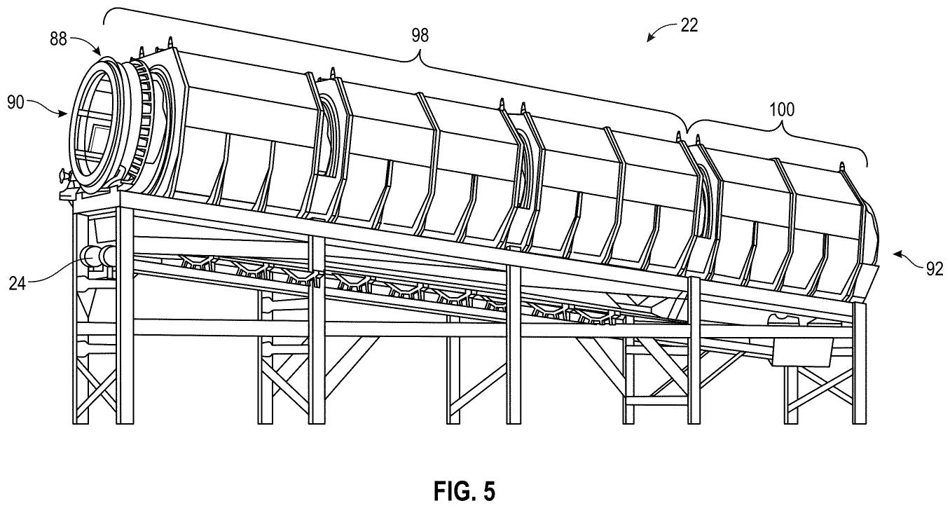

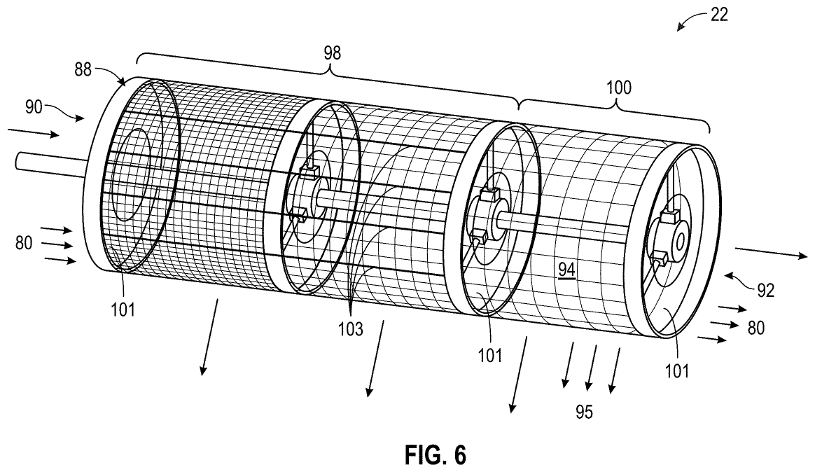

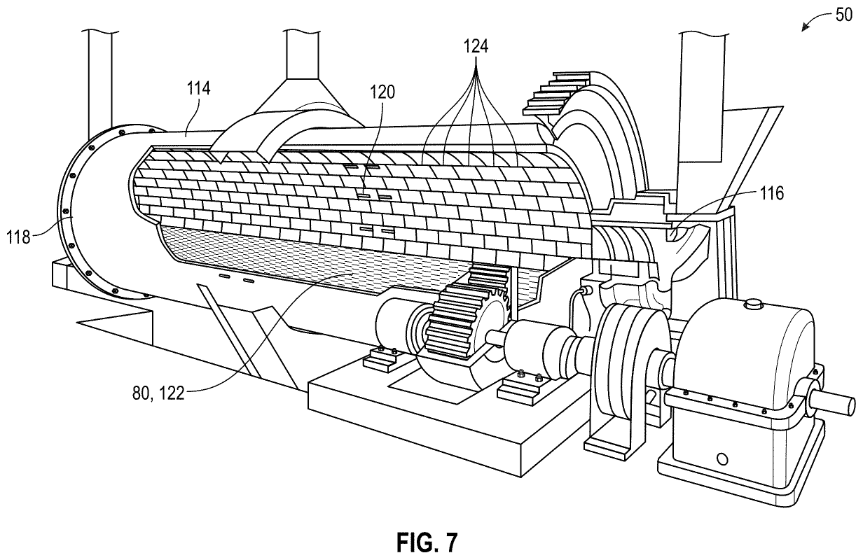

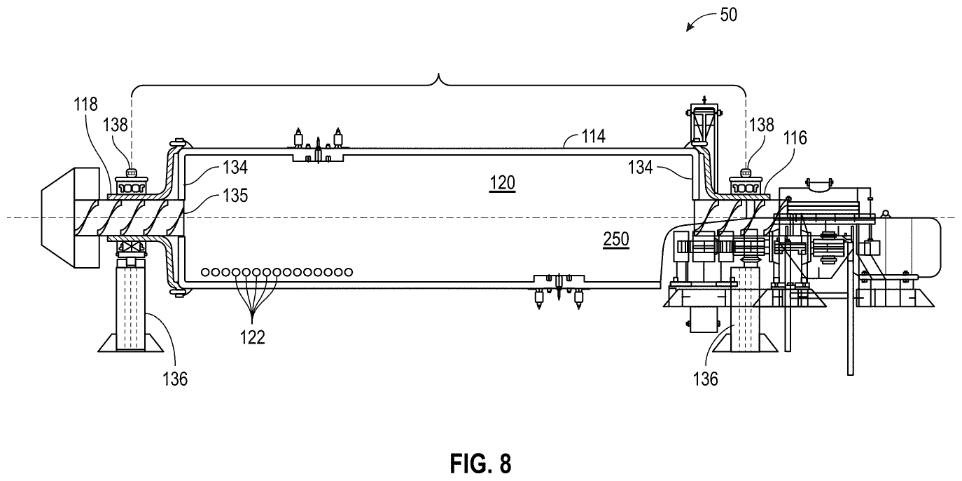

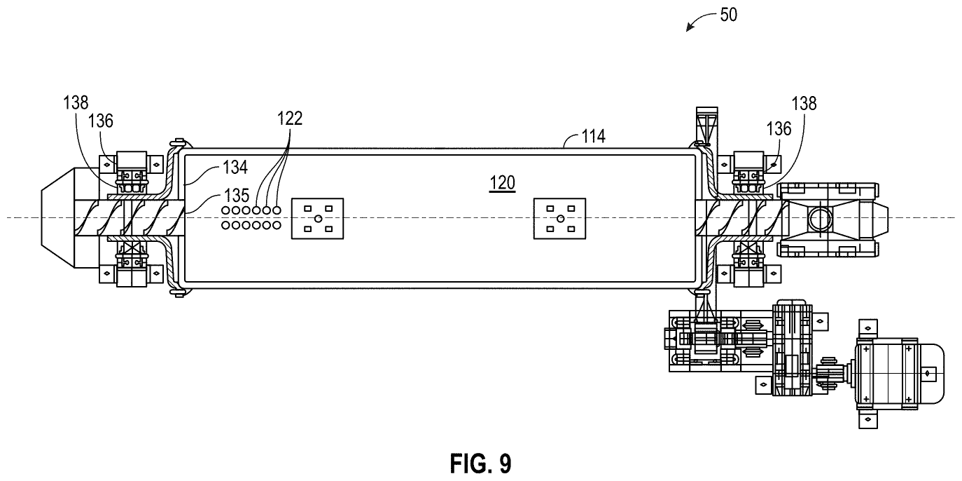

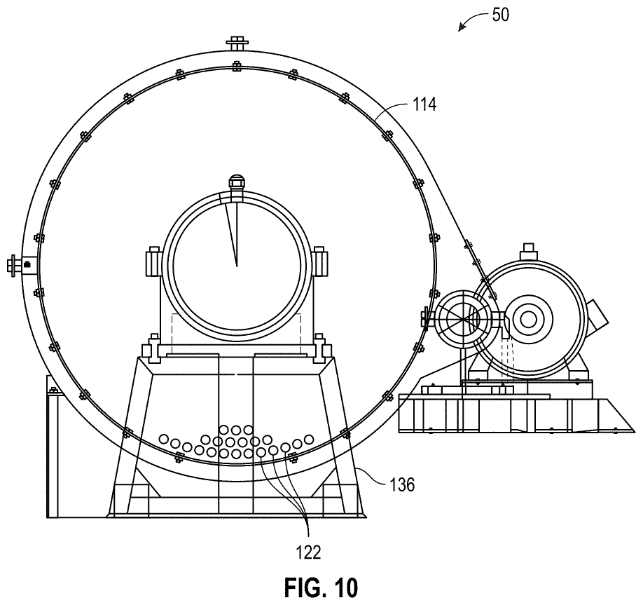

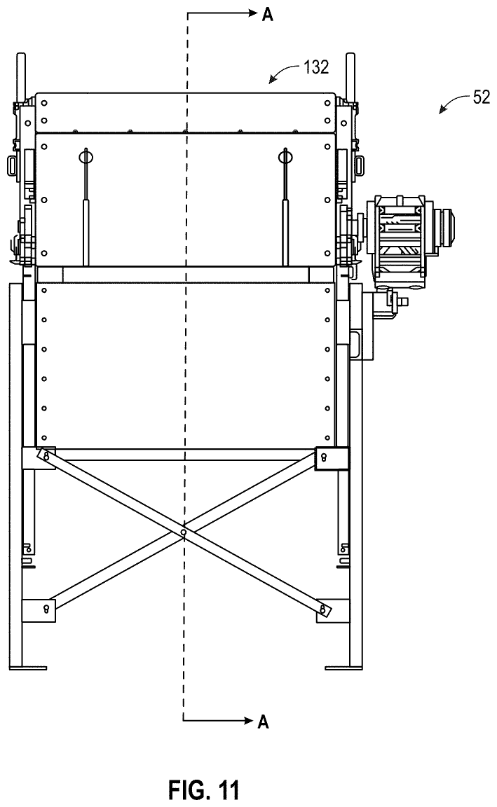

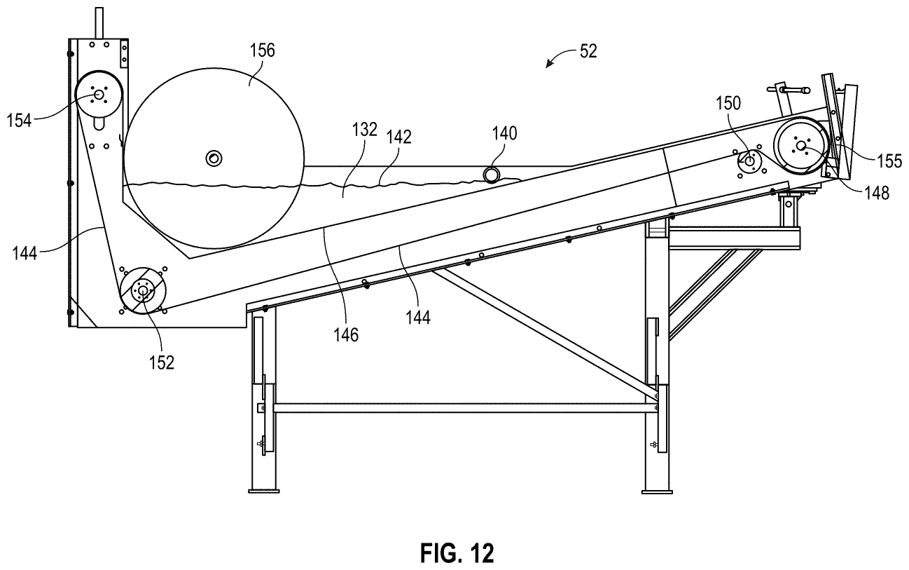

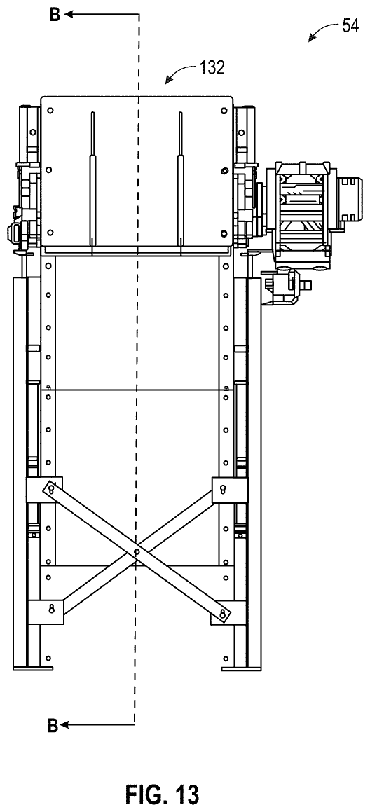

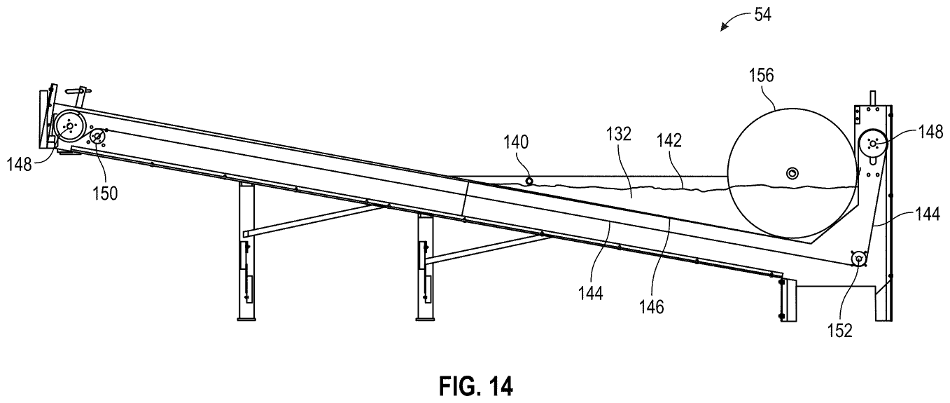

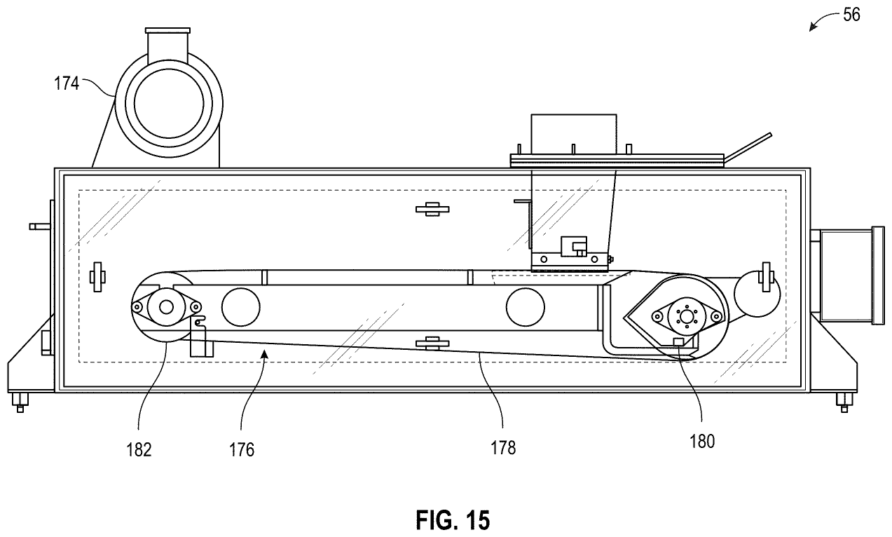

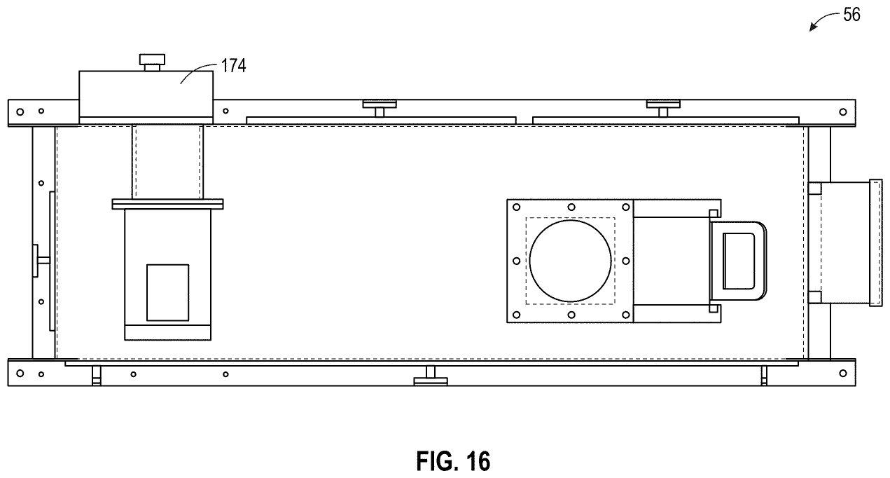

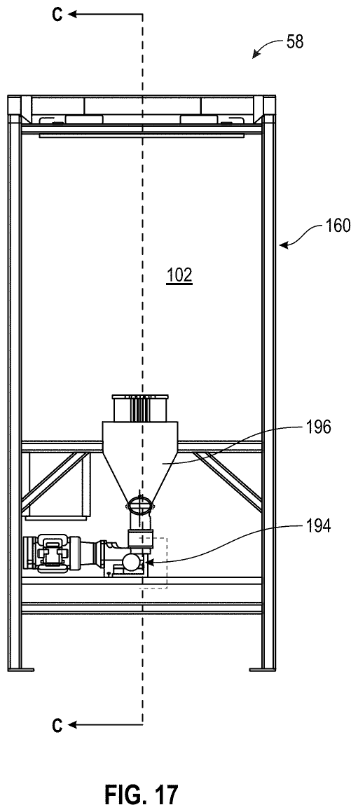

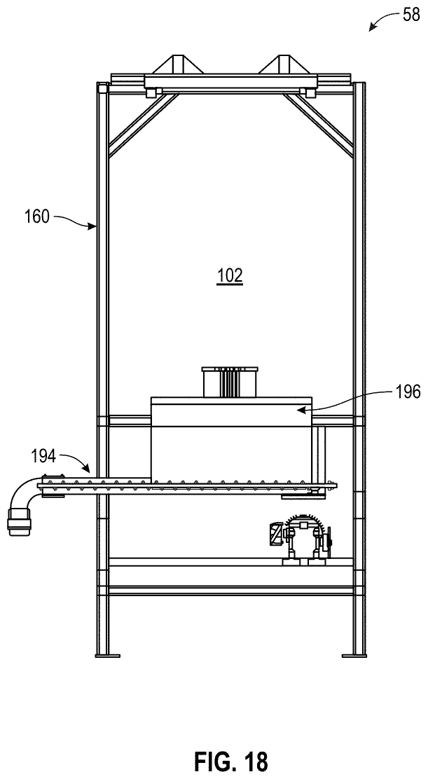

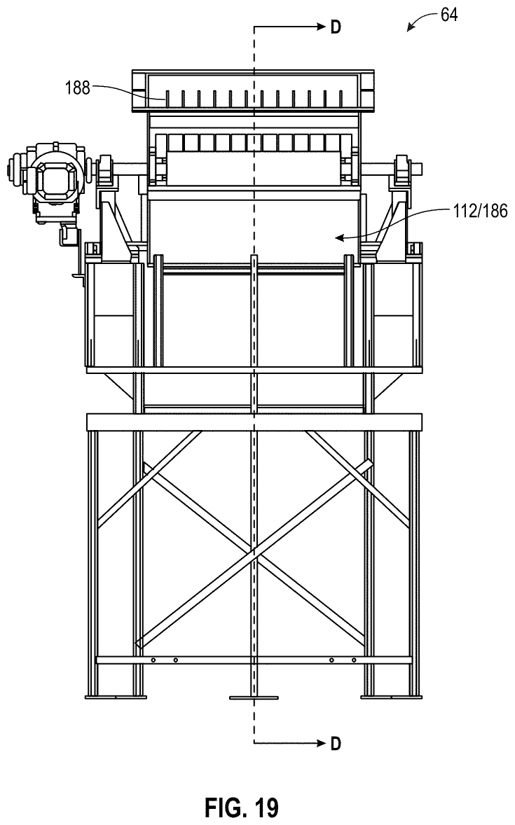

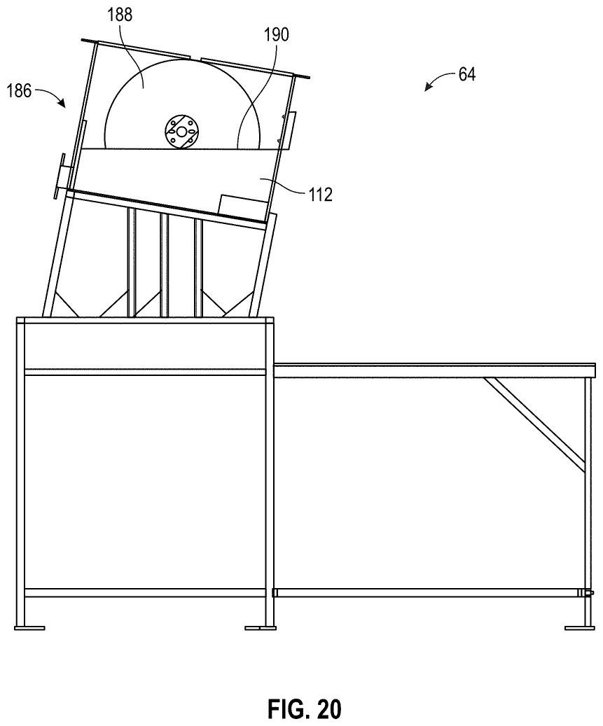

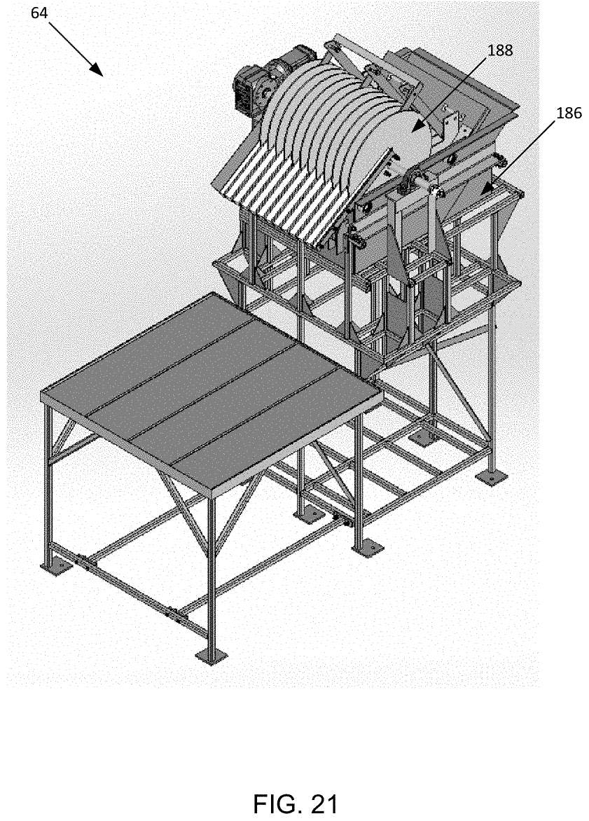

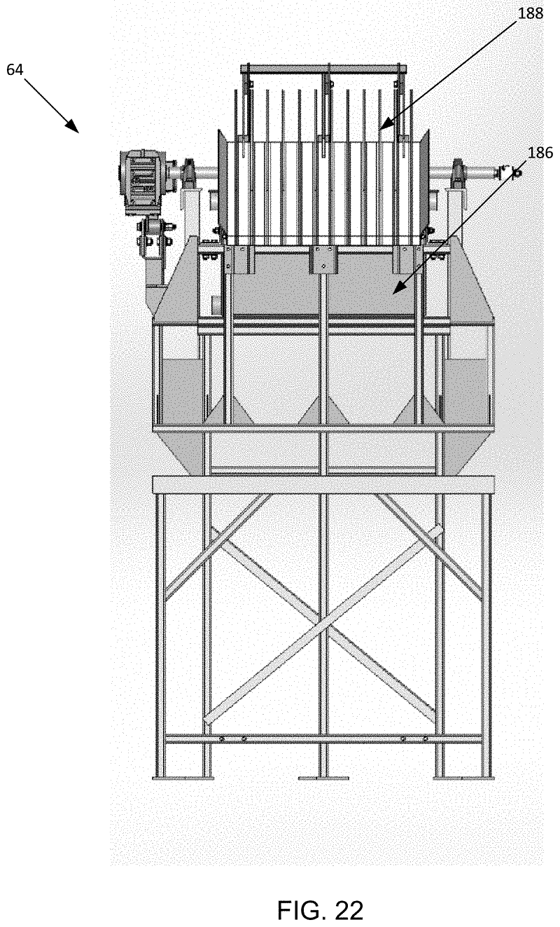

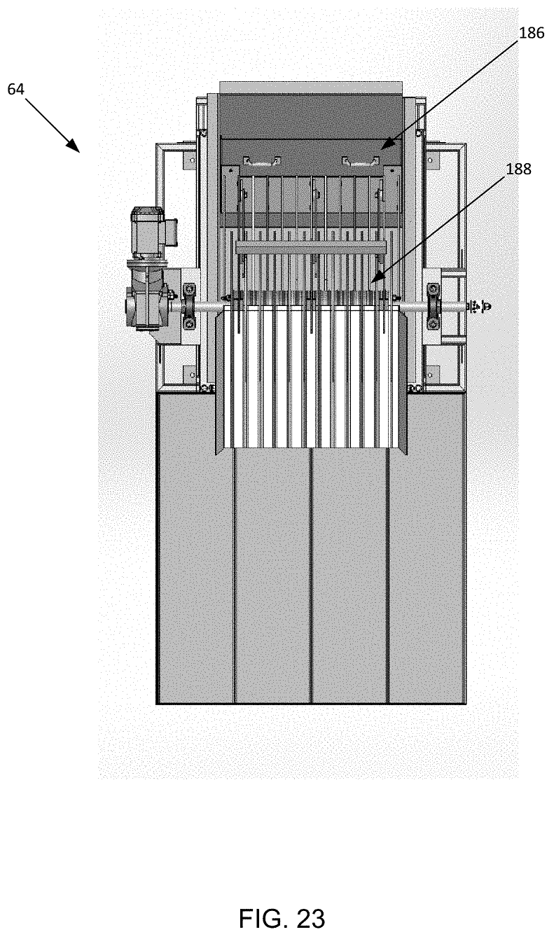

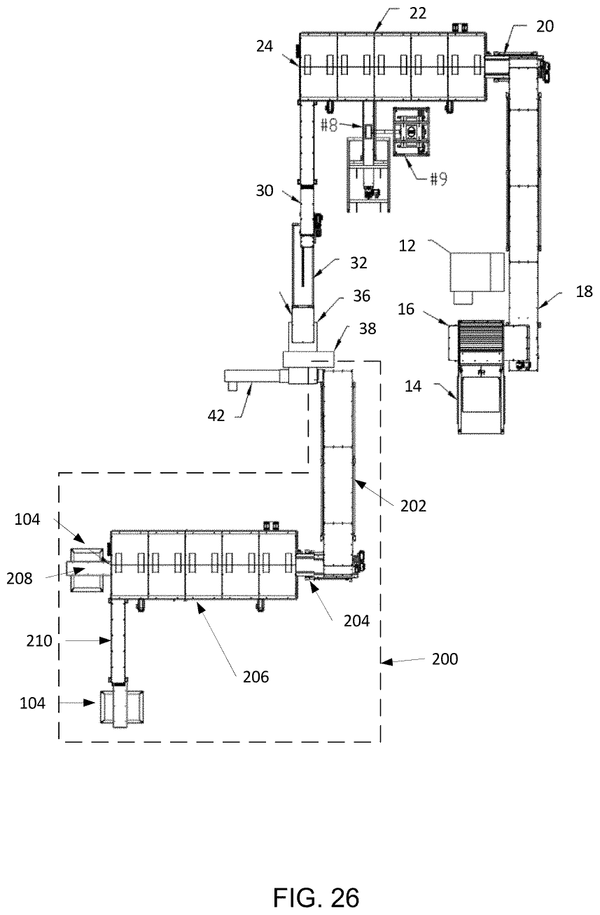

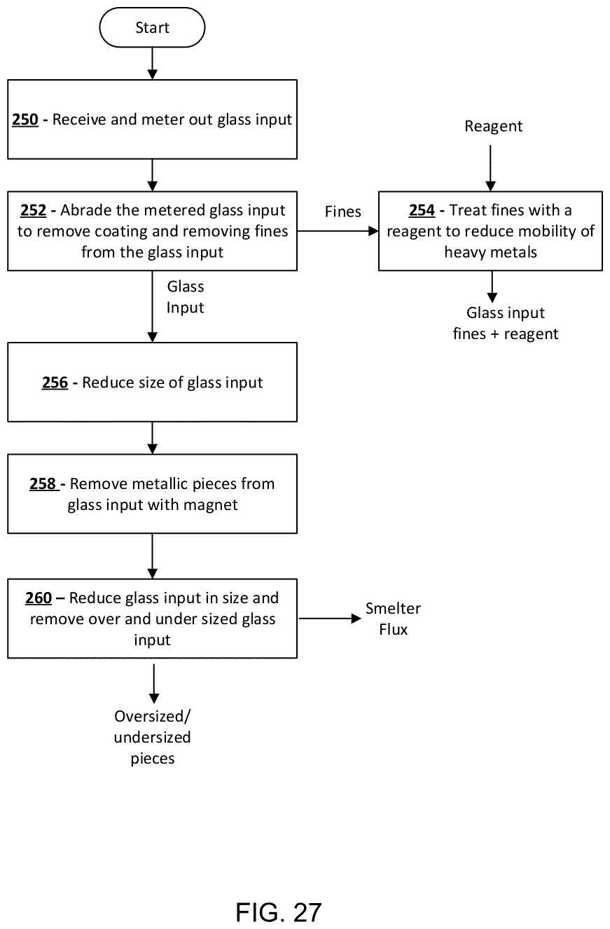

With reference to FIGS. 26-27 various additional features and alternatives of system 10 are presented. Some components of the system presented in FIGS. 26-27 are similar to components of the system 10 presented in FIGS. 1-25 and therefore all of the teaching presented herein with respect to FIGS. 1-25 applies equally to and is incorporated into the teaching presented in FIGS. 26-27 unless specifically stated otherwise.

It is recognized that the processing of glass input 80 or other bulk input 80 material as described with reference to FIGS. 1-25 may produce various product materials, prior to removal of lead and/or heavy metals, that may be useful in various industries. As one example, once glass input has been processed by trommel 22 to remove outer coatings, the glass input may useful as smelter flux to facilitate, for example, removal of impurities in various smelter processes.

FIG. 26 shows an alternative arrangement of system 10 configured for production of smelter flux. System 10 is formed of any suitable size, shape and design and is configured to facilitate processing of glass input 80 for the production of smelter flux.

In the arrangement shown, as one example, system 10 includes: dust collector 12, box tipper 14, surge hopper with feeder 16, first incline conveyor 18, trommel feed conveyor 20, trommel 22, trommel fines conveyor 24, trommel fines discharge conveyor 26, trommel fines treatment conveyor 28, drag chain conveyor 30, pulverizer 32, pulverizer screw conveyor 34, under magnet belt conveyor 36, overhead belt magnet separator 38, smelter flux lead removal reversing conveyor 40, as previously described with reference to FIG. 1. In the arrangement shown in FIG. 26, as one example, system 10 additionally includes a smelter flux processing line 200.

In this example arrangement shown in FIG. 26, system does not include lead removal processing line 41 or components thereof including spanner conveyor 42, second incline conveyor feed conveyor 44, second incline conveyor 46, ball mill feed conveyor 48, ball mill 50, first sump conveyor 52, second sump conveyor 54, glass weigh conveyor 56, glass treatment feeder 58, glass discharge conveyor 60, glass collection conveyor 62, electrolysis machine 64, electrolysis rectifier 66, briquette machine feed conveyor 68, and/or briquette machine 70, among other components, pieces, systems and features. However, the embodiments are not so limited. Rather it is contemplated, that in one or more arrangements, system 10 may include both lead removal processing line 41 and smelter flux processing line 200.

### Smelter Flux Processing Line 200:

Smelter flux processing line 200 is formed of any suitable size, shape and design and is configured to facilitate processing of glass input 80 received conveyor 40 to for smelter flux.

In the arrangement shown, as one example, smelter flux processing line 200 includes a third incline conveyor 202, a second trommel feed conveyor 204, a second trommel 206, an over/under conveyor 208 and a fourth incline conveyor 210, among other components.

Third Incline Conveyor 202:

In the arrangement shown, as one example, system 10 includes a third incline conveyor 202. Third incline conveyor 202 is formed of any suitable size, shape and design and is configured to receive glass input 80 from smelter flux lead removal reversing conveyor 40 and dispense glass input 80 for use in second trommel 206. In the arrangement shown, as one example, third incline conveyor 202 is formed of a conveying device, such as a belt, drag chain, auger, bucket elevator, or the like, or any other material handling system. In the arrangement shown, as one example, third incline conveyor 202 elevates glass from the smelter flux lead removal reversing conveyor 40 to the second trommel feed conveyor 204 that loads second trommel 206.

Second Trommel Feed Conveyor 204:

In the arrangement shown, as one example, system 10 includes a second trommel feed conveyor 204. Second trommel feed conveyor 204 is formed of any suitable size, shape and design and is configured to receive glass input 80 from third incline conveyor 202 and dispense glass input 80 for use in second trommel 206. In the arrangement shown, as one example, second trommel feed conveyor 204 is formed of a conveying device, such as a belt, drag chain, auger, hopper, gate, bucket elevator or the like, or any other material handling system. In the arrangement shown, as one example, second trommel feed conveyor 204 feeds glass input 80 into the second trommel 206 for processing.

Second Trommel 206:

In the arrangement shown, as one example, system 10 includes a second trommel 206. Second trommel 206 is formed of any suitable size, shape and design and is configured to facilitate breaking and sorting of glass input 80 pieces by size. In this example arrangement, second trommel 206 is similar to trommel 22 but includes two layers of perforated material (not shown) to facilitate separation and removal of glass input 80 pieces that are larger than or smaller than a target size range. As an illustrative example, a customer may request a smelter flux product in a size range of 3/32 inch to ¾ inch. As trommel 22 is operated, glass input 80 pieces that are between ¾ inch and 3/32 inch output to fourth incline conveyor. Glass input 80 pieces that are larger than ¾ inch and glass input 80 pieces that are smaller than 3/32 inch are separated by the perforated material and transported to a bulk storage container 104 by over/under conveyor 208.

Over/Under Conveyor 208:

In the arrangement shown, as one example, system 10 includes an over/under conveyor 208. Over/under conveyor 208 is formed of any suitable size, shape and design and is configured to collect and discharge the oversized and under sized glass input 80 pieces to a bulk storage container 104. In the arrangement shown, as one example, over/under conveyor 208 is formed of a conveying device, such as a belt, drag chain, auger, hopper, gate, bucket elevator or the like or any other material handling device or system.

Third Incline Conveyor 210:

In the arrangement shown, as one example, system 10 includes a third incline conveyor 210. Third incline conveyor 210 is formed of any suitable size, shape and design and is configured to collect and discharge the oversized and under sized glass input 80 pieces to a bulk storage container 104. In the arrangement shown, as one example, third incline conveyor 210 is a belt type conveyor. Use of the belt conveyor permits visual inspection of the glass input 80 material output from second trommel 206 for quality control. A quality control technician may remove any nonconforming pieces before glass input 80 pieces to a bulk storage container 104 for use as smelting flux. Alternately, third incline conveyor 201 may include any other type of conveying device, such as a drag chain, auger, hopper, gate, bucket elevator or the like or any other material handling device or system.

Example Process:

FIG. 27 shows an example process for production of smelter flux from glass input 80 material. At block 250, glass input 80 material is received and metered out. The glass input 80 material is received and metered out using for example, box tipper 14 and surge hopper with feeder 16 as previously described. However, it is contemplated that various arrangements may additionally or alternatively use any other mechanism, device, or means for receiving and metering of a glass material.

At block 252, the metered glass material is abraded to remove any coating on the glass material. Fines 95 generated by the abrading are also separated at block 252. In some various arrangements, the coating may be removed using, for example, trommel 22 as previously described. However, it is contemplated that various arrangements may additionally or alternatively use any other mechanism, device, or means to physically remove a coating from the glass input 80 material. It is also recognized that some types or sources of glass input 80 material may not have a coating requiring removal. Accordingly, it is contemplated that is one or more arrangement, processing at block 252 may be omitted.

At block 254, the separated fines 95 are treated with a reagent 102 to reduce mobility of heavy metals in the fines 95. In some various arrangements, the fines may be transported and treated with reagent 102 using, for example, trommel fines conveyor 24, trommel fines discharged conveyor 26, and trommel fines treatment conveyor 28 as previously described. However, it is contemplated that various arrangements may additionally or alternatively use any other mechanism, device, or means to transport and treat fines 95 with reagent 102.

At block 256, glass input 80 is processed to reduce the size of pieces forming the glass input 80. However, it is recognized that in some arrangements and/or some sources of glass material, it may not be necessary to reduce the size of pieces forming the glass input 80 at block 256. Accordingly, in some arrangements, processing at block 256 may be omitted.

As previously described, some glass input 80 materials may include stray metallic pieces as a result of harvesting the glass input 80 material from recycled consumer products. At block 258, metallic pieces are removed from the glass input 80 with a magnet. Additionally or alternatively, metal may be removed with any other mechanism, device, or means to separate stray metal pieces from the glass input 80 materials

At block 260, the glass input 80 is reduced or further reduced in size and sorted to produce smelter flux of a target size. The glass input 80 material may be reduced in size and sorted to remove over size and under size pieces, for example, second trommel 206 as previously described. However, it is contemplated that various arrangements may additionally or alternatively use any other mechanism, device, or means for reducing glass input 80 material in size and sorting glass input pieces to remove pieces that are outside a target size range.

From the above discussion it will be appreciated that the system and method for reclamation of leaded glass, presented herein improves upon the state of the art. Specifically, the system and method for the reclamation of leaded glass presented herein: is more environmentally friendly than existing systems and methods; is more efficient than existing systems and methods; is safer to use than existing systems and methods; does not require melting of the glass to remove lead; does not require high temperatures; reduces emissions into the atmosphere as compared to existing systems and methods; is cost effective to use; can be used with a variety of input materials; is not limited to use with just television and computer monitor CRTs; can be used with flat-screen televisions and computer monitors; is repeatable; is highly efficient; provides high-quality results; removes a high percentage of lead from glass; utilizes a chemical process rather than a smelting process; is easy to use; has a relatively simple design; is robust; has a long useful life; has relatively few components; has a minimum number of parts; is relatively easy to set-up and install; is environmentally friendly; will improve recycling rates of leaded glass; will reduce the amount of leaded glass that is improperly disposed of in landfills; and/or allows for the non-thermal recovery of lead from glass, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A method for the reclamation of heavy metal from glass, the steps comprising:
providing a glass input, the glass input having a heavy metal content within the glass input, the glass input having at least one coating on a surface of the glass input;
removing the at least one coating on a surface of the glass input by tumbling the glass input through an abrasion process;
pulverizing the glass input into particulate matter while the glass input is exposed to a chemical solution;
dissolving heavy metal from a surface of the pulverized glass input particulate matter using the chemical solution;
separating the pulverized glass input particulate matter from the chemical solution;
reclaiming heavy metal from the chemical solution using an electrolysis process.

2. The method of claim 1, wherein the glass input is formed of cathode ray tubes.

3. The method of claim 1, wherein the glass input is formed of cathode ray tubes that are broken into pieces of heavy metal glass.

4. The method of claim 1, wherein the ball mill includes a plurality of balls within the ball mill that pulverize the glass input into particulate material.

5. The method of claim 1, wherein the chemical solution is a base.

6. The method of claim 1, wherein the chemical solution is a base in the range of 10-14 Ph.

7. The method of claim 1, wherein the chemical solution includes potassium hydroxide.

8. The method of claim 1, further comprising the step of applying a reagent to the pulverized glass input particulate matter after separating the pulverized glass input particulate matter from the chemical solution so as to neutralize remaining heavy metal content in the separated pulverized glass input particulate matter.

9. The method of claim 1, wherein separating the pulverized glass input particulate matter from the chemical solution occurs in a settling tank wherein the pulverized glass input particulate matter is allowed to settle out of the chemical solution.

10. The method of claim 1, wherein separating the pulverized glass input particulate matter from the chemical solution occurs in a settling tank wherein the pulverized glass input particulate matter settles onto a belt that carries the pulverized glass input particulate matter out of the chemical solution.

11. The method of claim 1, wherein the glass input includes lead as part of the heavy metals.

12. The method of claim 1, wherein the particulate matter formed by the ball mill is in the size range of 0.1″ and 0.003″.

13. The method of claim 1, wherein the heavy metal content of the glass input is in the range of 1% to 25% prior performing the method for the reclamation of heavy metal glass.

14. The method of claim 1, wherein the heavy metal content of the glass input is in the range of 0.001% to 5% after performing the method for the reclamation of heavy metal glass.

15. A method for the reclamation of metal from glass, the steps comprising:
providing a glass input, the glass input having a metal content within the glass input, the glass pulverizing the glass input into particulate matter to increase surface area of the glass input;
dissolving metal from a surface of the pulverized glass input particulate matter using a chemical solution;
separating the pulverized glass input particulate matter from the chemical solution;
reclaiming heavy metal from the chemical solution using an electrolysis process.

16. The method of claim 15, wherein the pulverizing of the glass input is performed while the glass input is exposed to a chemical solution;

17. The method of claim 15, further comprising, prior to the pulverizing of the glass input:
removing at least one coating on a surface of the glass input by tumbling the glass input through an abrasion process using a trommel;

18. The method of claim 15, wherein the pulverizing of the glass input is performed using a ball mill.

19. The method of claim 15, wherein the heavy metal is lead.

20. A system for the reclamation of leaded glass, comprising:
a trommel;
a ball mill;
the ball mill having a plurality of balls therein;
a settling tank;
wherein when a glass input having a lead content within the glass input and at least one coating on a surface of the glass input is passed through the trommel, the trommel removes the at least one coating on a surface of the glass input;
wherein, after the at least one coating on a surface of the glass input is removed, when the glass input is passed through the ball mill the plurality of balls pulverize the glass input into particulate matter while the glass is exposed to a chemical solution;
wherein when the pulverized glass input particulate matter is exposed to the chemical solution lead is dissolved from a surface of the pulverized glass input particulate matter by the chemical solution;
wherein, after lead is dissolved from a surface of the pulverized glass input particulate matter by the chemical solution, the pulverized glass input particulate matter is separated from the chemical solution by settling in the settling tank.

21. The system of claim 20, wherein the glass input is formed of cathode ray tubes that are broken into pieces of leaded glass.

22. The system of claim 20, wherein the chemical solution is a base.

23. The system of claim 20, wherein the chemical solution includes potassium hydroxide.

24. The system of claim 20, wherein the settling tank is configured to separate the pulverized glass input particulate matter from the chemical solution;
wherein the settling tank includes a belt that carries the pulverized glass input particulate matter out of the chemical solution.

25. The system of claim 20, wherein the ball mill is configured to form particulate matter is in the size range of 0.1″ and 0.003″.
